(19) United States
(12) Patent Application Publication
(10) Pub. No.: US 2011/0104505 A1
(43) Pub. Date: May 5, 2011

(54) LAMINATED BODY AND CIRCUIT WIRING BOARD

(76) Inventors: Kunio Mori, Iwate (JP); Yusuke Matsuno, Iwate (JP)

(21) Appl. No.: 12/999,213

(22) PCT Filed: Jun. 4, 2009
(86) PCT No.: PCT/JP09/60266

§ 371 Date: Dec. 15, 2010

(51) Int. Cl. B32B 7/12; B32B 15/06; B32B 25/04; B32B 37/12

(52) U.S. Cl. 428/447; 428/448; 156/182; 156/306.6

(57) ABSTRACT

Provided is a laminated body which solves, all at once, the issues of conventional methods, such as adhesiveness to a board having low surface roughness, stress concentration relaxing, reliability improvement, high adhesiveness (especially, that of a conductor layer), heat resistance, almighty characteristics (being adherable irrespective of the type of an adhesive), in manufacture of laminated bodies. The laminated body is formed by having an entropically elastic molecular adhesive layer between two boards, and the entropically elastic molecular adhesive layer is composed of an entropically elastic material layer, and a layer of a molecular adhesive having a group which can be bonded to the entropically elastic material layer.

### TECHNICAL FIELD

The present invention relates to a laminated body that is manufactured by forming an entropy elastic molecular bonding layer between two boards, wherein the above elastic molecular bonding layer is composed of an entropy elastomer layer and a molecular adhesive layer. The present invention relates to electronic mounting parts, precision machine parts, building strictures, circuit wiring boards, decorative plating commodities, and bonded complex commodities each of which is composed of the above laminated body.

### BACKGROUND ART

Conventionally, the laminated body employing various adhesives has been put into practical use in the technological field such as the laminated body of the board and the circuit wiring board. The conventional bonding method, however, necessitates appropriately selecting the adhesives suitable for kinds of adherends, and yet causes a problem that a bonding force declines in final commodities due to an evil influence by a shape keeping function that the adhesive itself has, and the laminated body using the above adhesive is lacking a reliability (strength, endurance, etc.). In addition, with the case of the physical bonding to be typified by the use of the above adhesive, it is known that adhesiveness is enhanced owing to an anchor effect all the more as surface roughness of the board becomes larger, and on the other hand, when the board of which the surface roughness is large is used, particularly for the laminated body to be employed in the field demanding a high precision such as the circuit wiring board, a problem surfaces that it is difficult to attain miniaturization and densification thereof, and the laminated body is lacking in reliability.

The various bonding methods are being investigated so as to solve such problems, and a shift from a physical bonding method to a chemical bonding method is proposed as one of countermeasures therefor (for example, see Patent Literatures 1 to 3).

As it is, the conventional chemical bonding methods takes it as an important factor for attaining the bonding that smoothness of the board surface is high at the time of the bonding step, a distance between the boards is narrowed to an extent in which the reaction is enabled, the board is made of a material that can alleviate a stress concentration, and the like because the bonding originates in a molecularly chemical linkage, and thus, the chemical bonding methods are practically insufficient in alleviation of stress concentration, an improvement in reliability, high adhesiveness (especially, that of a conductor layer), heat resistance, universality (being adherable irrespective of a type of adherends), and the like, and particularly, are insufficient in an improvement in the adhesiveness of the board of which the surface roughness is large, an improvement in the adhesiveness of the board partners each having a shape keeping function, and the like.

Thus, the current situation is that the laminated body having solved the controversial points of the foregoing prior arts is not known even now.

### CITATION LIST

### Patent Literature

PTL 1: JP-P2006-213677A
PTL 2: JP-P2007-17921A
PTL 3: JP-P2007-119752A

### SUMMARY OF INVENTION

### Technical Problem

An object of the present invention is provide a laminated body that is capable of solving, all at once, the controversial points of the conventional methods such as an improvement in the adhesiveness to the board having large surface roughness that, particularly, becomes a task at the time of manufacturing the laminated body, alleviation of the stress concentration, an improvement in the reliability, high adhesiveness (especially, that of a conductor layer), heat resistance, and universality (being adherable irrespective of a type of adherends).

### Solution to Problem

As a result of various investigations and studies for the above-mentioned controversial problems, this inventor has found out the technology for, all at once, solving the controversial points of the prior arts such as an improvement in the adhesiveness to the board of which the surface roughness is large, the alleviation of the stress concentration, an improvement in the reliability, the high adhesiveness (especially, that of a conductor layer), the heat resistance, and the universality (being adherable irrespective of a type of adherends), each of which becomes task at the time of manufacturing the laminated body, by using the elastic molecular bonding layer that is composed of the entropy elastomer layer and the molecular adhesive layer when multilayering two boards. It can be said safely that the elastic molecular bonding layer of the present invention is a truly epoch-making invention having changed a concept of the conventional adhesives.

That is, the present invention is as follows.

Item 1. A laminated body that is manufactured by forming the entropy elastic molecular bonding layer between two boards, wherein the above entropy elastic molecular bonding layer is composed of the entropy elastomer layer and the molecular adhesive layer.

Item 2. A laminated body according to the above-mentioned item 1, wherein the entropy elastic molecular bonding layer is formed by forming a molecular adhesive layer 1 on the board, forming the entropy elastomer layer on the above molecular adhesive layer 1, and furthermore multilayering a molecular adhesive layer 2 on the above entropy elastomer layer.

Item 3. A laminated body according to the above-mentioned item 1, wherein the entropy elastic molecular bonding layer is formed by previously forming the molecular adhesive layer on the surfaces of two boards, respectively, and interposing the entopic elastomer layer between the two boards each having the above molecular adhesive layer formed thereon.

Item 4. A laminated body according to one of the above-mentioned items 1 to 3, wherein the molecular adhesive layer is formed by reacting OH groups existing on the board surface with the molecular adhesive.

Item 5. A laminated body according to the above-mentioned item 1 or item 2, wherein the molecular adhesive layer is formed by reacting OH groups existing on the surface of the entropy elastomer layer with the molecular adhesive.

Item 6. A laminated body according to the above-mentioned item 1 to item 3, wherein the molecular adhesive layer is formed on all surface or one part of the surface of the board.

Item 7. A laminated body according to one of the above-mentioned item 1 to item 5, wherein the entropy elastomer layer is formed by bringing un-crosslinked or crosslinked entropy elastomer composition in contact with all surface or one part of the surface of the molecular adhesive layer, and bonding them under pressurization, by heat, and/or by an optical medium.

Item 8. A laminated body according to one of the above-mentioned item 1 to item 7, wherein the entropy elastomer layer contains one kind or more selected from a group that is composed of 1,4-cisbutadiene rubber (BR), acrylnitrile-butadiene copolymer rubber (NBR), ethylene-propylene-diene rubber (EPDM), fluoro rubber (FKM), epichlorohydrin rubber (CHR), fluorinated silicone rubber, peroxide type silicone rubber, addition-type silicone rubber and condensation-type silicone rubber.

Item 9. A laminated body according to one of the above-mentioned item 1 to item 8, wherein the molecular adhesive layer contains one kind or more of the molecular adhesives represented by the following general formula (1).

A-SiX¹₃₋ₙYₙ (1)

(In the formula, A is a group linkable to the entropy elastomer layer, X¹ could be identical and could be different, respectively, and is a hydrogen atom, or a saturated or unsaturated aliphatic hydrocarbon group having a carbon number of 1 to 10 that may contain substituted groups, Y is an alkyloxy group having a carbon number of 1 to 10, and n represents an integer of 1 to 3.)

Item 10. A laminated body according to the above-mentioned item 9, wherein the molecular adhesive is an molecular adhesive represented by the following general formulas (2) to (6).

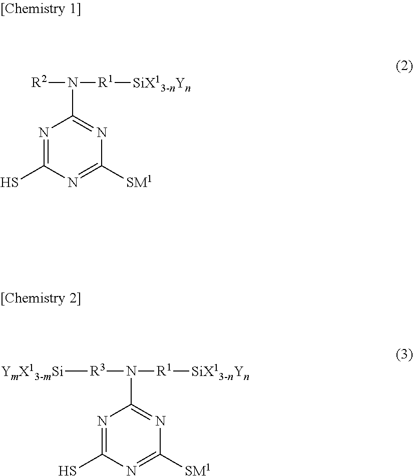

(In the formula, each of R¹ and R³ could be identical and could be different, is a single bond, a saturated or unsaturated aliphatic hydrocarbon group having a carbon number of 1 to 20, or an aromatic hydrocarbon group, and the above aliphatic hydrocarbon group or aromatic hydrocarbon group may contain —NH—, —CO—, —O—, —S—, or —COO—. R² is a hydrogen atom, a saturated or unsaturated aliphatic hydrocarbon group having a carbon number of 1 to 10 that may contain substituted groups, or an aromatic hydrocarbon group that may contain substituted groups, X¹ could be identical and could be different, respectively, and is a hydrogen atom, or a saturated or unsaturated aliphatic hydrocarbon group having a carbon number of 1 to 10 that may contain substituted groups, Y is an alkyloxy group having a carbon number of Ito 10, each of n and m represents an integer of 1 to 3, and M¹ is H, Li, Na, K, or Cs.)

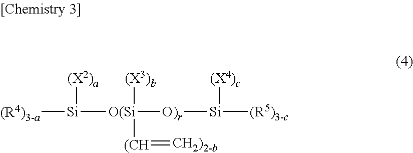

(In the formula, each of R⁴ and R⁵ could be identical and could be different, and is a saturated or unsaturated aliphatic hydrocarbon group having a carbon number of 1 to 10 that may contain substituted groups, or an aromatic hydrocarbon group that may contain substituted groups. Each of X² to X⁴ is a saturated or unsaturated aliphatic hydrocarbon group having a linear or branched carbon chains with a carbon number of 1 to 10 that may contain substituted groups, an aromatic hydrocarbon group that may contain substituted groups, or an alkyloxy group having a carbon number of 1 to 10 and yet at least one of X² and X⁴ is an alkyloxy group. Each of a and c represents an integer of 0 to 3, b represents an integer of 0 to 2, and r represents an integer of 0 to 100.)

[X⁵_{d}(X⁶O)_{3-d}SiR⁶]_{c}Z (5)

(In the formula, each of X⁵ and X⁶ could be identical and could be different, and is a saturated or unsaturated aliphatic hydrocarbon group having a carbon number of 1 to 1, R⁶ is a bivalent aliphatic hydrocarbon group having a carbon number of 1 to 18, or an aromatic hydrogen group, and the above aliphatic hydrocarbon group may contain —NH—, —CO—, —O—, —S—, —COO—, or —C₆H₄—. Z is —SH—, —SCSN(CH₃)₂, —SSCSN(CH₃)₂, —SCSN(C₂H₅)₂, —SCSN(C₄H₉)₂, —SCSN(C₈H₁₇)₂, —SS—, —SSS—, —SSSS—,

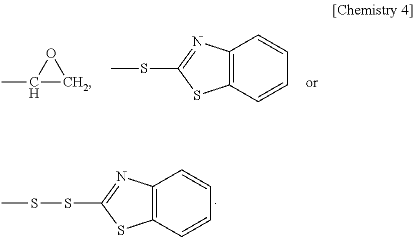

d is 0, 1 or 2, and e is 1 or 2).

H₂N—R⁷—SiX¹₃₋ₙYₙ (6)

(In the formula, R⁷ is a saturated or unsaturated aliphatic hydrocarbon group having a carbon number of 1 to 10 that may contain substituted groups, or an aromatic hydrocarbon group that may contain substituted groups, each of X¹ and Y is similar to the foregoing, and n represents an integer of 1 to 3.)

Item 11. A laminated body according to one of the above-mentioned item 1 to item 10, wherein the board is one kind of the board or more selected from a group that is comprised of metal, ceramics, resin, and a complex thereof.

Item 12. A laminated body according to one of the above-mentioned item 1 to item 11, wherein at least one of the two boards is a conductive board.

Item 13. A laminated body according to the above-mentioned item 12, wherein the conductive board is formed on all surface or one part of the surface of the molecular adhesive layer.

Item 14. A laminated body according to the above-mentioned item 12 or item 13, wherein the conductive board is formed by electroless plating after supporting catalysts on the molecular adhesive layer.

Item 15. A laminated body according to the above-mentioned item 14, wherein the conductive board is formed by copper plating.

Item 16. A circuit wiring board comprised of the laminated body according to one of the above-mentioned item 1 to item 15.

Item 17. A decorative plating commodity comprised of the laminated body according to one of the above-mentioned item 1 to item 15.

Item 18. A bonded complex commodity comprised of the laminated body according to one of the above-mentioned item 1 to item 16.

### Advantageous Effect of Invention

The present invention is capable of solving, all at once, the controversial points of the prior arts such as the adhesiveness to the board of which the surface roughness is large, alleviation of the stress concentration, an improvement in the reliability, the high adhesiveness (especially, that of a conductor layer), the heat resistance, and the universality (being adherable irrespective of a type of adherends), each of which is a task at the time of manufacturing the laminated body, by using the elastic molecular bonding layer that is composed of the entropy elastomer layer and the molecular adhesive layer when multilayering two boards having a shape keeping function.

### BRIEF DESCRIPTION OF DRAWINGS

FIG. 1 is a view illustrating a cumulative technique.

FIG. 2 is a view illustrating a sandwiching technique.

FIG. 3 is a view illustrating one exemplary embodiment of the laminated body of the present invention.

FIG. 4 shows a chart of measuring XPS.

### REFERENCE SIGNS LIST

1 board 1
2 molecular adhesive layer 1
3 entropy elastomer layer 1
4 molecular adhesive layer 2
5 board 2
6 molecular adhesive layer 3
7 entropy elastomer layer 2
8 molecular adhesive layer 4
9 board 3

### DESCRIPTION OF EMBODIMENTS

The present invention relates to the laminated body that is manufactured by forming the elastic molecular bonding layer between two boards, wherein the above elastic molecular bonding layer is composed of the entropy elastomer layer and the molecular adhesive layer.

1. Board

Each of the two boards (hereinafter, referred to as a board 1 and board 2) to be used by the present invention could be identical or different, and is not particularly limited so long as it has a shape keeping function.

Herein, the so-called the board having a shape keeping function signifies a board in which fine shapes (for example, fine irregularities) of several nm to several tens of nm of the board surface are hardly changed under a pressure level applied at the moment of the multilayering (bonding) in a temperature (especially, a room temperature) in which the laminated body of the present invention is used. For example, one kind of the board or more selected from a group that is comprised of metal, ceramics, resin, and a complex thereof falls under the board having a shape keeping function. On the other hand, the entropy elastomer such as rubber, in which fine shapes of several nm to several tens of nm of the surface thereof are changed under a pressure level applied at the moment of the multilayering (bonding) in many cases, do not usually fall under the board having a shape keeping function.

As metal that is used as the board having a shape keeping function, for example, plates, foils and laminated plates thereof, curved shapes, and the like of Al, Mg, Zn, Cu, Sn, Ag, Ni, Si, Au, Fe, Pt, Mo, W, and an alloy thereof can be listed. The boards of Cu, Ag, Ni, Au, Ni/Fe, Co, Fe, Pt, and brass, out of these metal boards, can be also formed by plating.

As ceramics, plates, foils, curved shapes, laminated plates thereof, and the like of oxides etc. of Al, Mg, Zn, Cu, Sn, Ag, Ni, or Si can be listed.

As resin, shaped bodies such as films, plates, and curved shapes of polymer materials and crosslinked materials such as cellulose and derivatives thereof, hydroxyethlycellulose, starch, diacetate cellulose, surface saponified vinyl acetate resin, low-density polyethylene, high-density polyethylene, i-polypropylene, petroleum resin, polystyrene, s-polystyrene, chroman-indene resin, terpene resin, styrene-divinylbenzene copolymer, ABS resin, polymethyl acrylate, polyethyl acrylate, polyacrylonitrile, methyl methacrylate, ethyl methacrylate, polycyanoacrylate, polyvinyl acetate, polyvinyl alcohol, polyvinyl formal, polyvinyl acetal, polyvinyl chloride, vinyl chloride-vinyl acetate copolymer, vinyl chloride-ethylene copolymer, polyvinylidene fluoride, vinylidene fluoride-ethylene copolymer, vinylidene fluoride-propylene copolymer, 1,4-transpolybutadiene, polyoxymethylene, polyethylene glycol, polypropylene glycol, phenol-formalin resin, cresol-formalin resin, resorcin resin, melamine resin, xylene resin, toluene resin, glyptal resin, modified glyptal resin, polyethylene terephthalate, polybutylene terephthalate, unsaturated polyester resin, acryl eater resin, polycarbonate, 6-nylon, 6,6-nylon, 6,10-nylon, polyimide, polyamide, polybenzimidazole, polyamideimide, silicon resin, silicone rubber, silicone, furan resin, polyurethane resin, epoxy resin, polyphenylene oxide, polydimethylphenylene oxide, blends of polyphenylene oxide or polydimethylphenylene oxide, and triallylisocyanurate, (polyphenylene oxide or polydimethylphenylene oxide, triallylisocyanurate, peroxide) blends, polyxylene, polyphenylenesulfide (PPS), polysulfone (PSF), polyethersulfone (PES), polyetheretherketone (PEEK), polyimide (PPI, kapton), liquid crystal resin, and blends of a plurality of these materials can be listed. So as to prevent transformation due to heat of these resins and resin compounds, keep the shapes, and reinforce them, the above-mentioned materials may be used in a three-dimensional manner by inserting fillers such as metal powder, metal fibers, ceramics, ceramics fibers, carbon blacks, calcium carbonate, talc, clay, kaolin, and fumed or baked silica, fibers such as rayon, nylon, polyester, vinylon, steel, Kevlar fiber (Registered Trademark of Du Pont), carbon fibers, and glass fibers, and clothes in some cases, and by adding crosslinking agents such as peroxide, and multifunctional monomer in some cases.

The so-called complex of metal, ceramics, and resin (including rubber), which signifies a mixture of powdered materials of metal or ceramics, and resin, is used as plates, foils and curved shapes.

The board 1 and the board 2 may be appropriately selected responding to use intention of the laminated body as a combination thereof, and for example, a combination of an aluminum plate and a glass epoxy resin board, a combination of glass and copper, a combination of glass and glass, a combination of glass and SUS, a combination of glass epoxy and copper, a combination of PET and copper, a combination of magnesium and aluminum, a combination of polyimide and copper, a combination of polypropylene and aluminum, a combination of nylon and iron, and the like are preferable.

Further, when the laminated body of the present invention is used as a circuit wiring board etc., preferably, at least one of the two boards is a conductive board, preferably the above conductive board is a conductive plating layer formed by plating, and particularly preferably, the above plating is copper plating.

Thickness or size of the board may be appropriately selected responding to use intention thereof, and is not particularly limited.

2. Entropy Elastic Molecular Bonding Layer

The entropy elastic molecular bonding layer to be used in the present invention is composed of the entropy elastomer layer and the molecular adhesive layer. While the effective thickness of the entropy elastic molecular bonding layer cannot uniquely be decided because it differs dependent upon the feature for which the commodity aims, and can be appropriately decided according to the aspect of the commodity, the thickness of 0.1 to 5,000 μm is preferable, and the thickness of 1 to 2,000 μm is more preferable when the strength of the interface is particularly required. When the thickness of the entropy elastic molecular bonding layer is less than 0.1 μm, it is difficult to attain the required formability and the alleviation of the stress and an improvement in the reliability are not sufficiently accomplished in some cases, and when the thickness of the entropy elastic molecular bonding layer exceeds 5,000 μm, it is difficult to attain miniaturization and densification of the laminated body depending upon the commodity, and further, a tendency in which a production cost is increased and productivity is lowered is brought about.

Hereinafter, respective layers will be explained.

2.1 Molecular Adhesive Layer

In the present invention, the so-called molecular adhesive layer signifies a layer that is composed of the molecular adhesive, and the molecular adhesive layer containing one kind or more of the molecular adhesives represented by the following general formula (1) is preferable.

A-SiX¹₃₋ₙYₙ (1)

(in the formula, A is a group linkable to the entropy elastomer layer, X¹ could be identical and could be different, respectively, and is a hydrogen atom, or a saturated or unsaturated aliphatic hydrocarbon group having a carbon number of 1 to 10 that may contain substituted groups, Y is an alkyloxy group having a carbon number of 1 to 10, and n represents an integer of 1 to 3.)

Herein, the so-called molecular adhesive contains both of the group chemically linkable to OH groups existing on the board surface etc. (for example, the alkoxysilyl group represented by SiX¹₃₋ₙYₙ within the general formula (1)) and the group chemically linkable to the entropy elastomer layer (for example, the crosslinking reactive group represented by A within the general formula (1)), and chemically linking the above molecular adhesive to the surfaces of the board and the entropy elastomer makes it possible to provide the laminated body having an excellent adhesiveness. The molecular adhesives may furthermore have the other groups, for example, the functional groups chemically linkable to metal besides the foregoing functional group. When the board is formed by metal plating, or the like, the molecular adhesive is chemically linked to the metal plating owing to the functional group that is chemically linked to this metal.

As a specific example of the molecular adhesive represented by the general formula (1), the molecular adhesives represented by the general formulas (2) to (6) having the structure as describe below can be listed.

General Formulas (2)

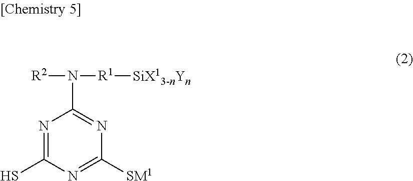

General Formula (3)

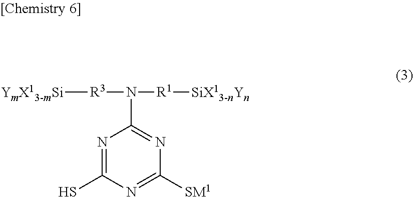

(In the formula, each of R¹ and R³ could be identical and could be different, is a single bond, a saturated or unsaturated aliphatic hydrocarbon group having a carbon number of 1 to 20, or aromatic hydrocarbon group, and the above aliphatic hydrocarbon group or aromatic hydrocarbon group may contain —NH—, —CO—, —O—, —S—, or —COO—. R² is a hydrogen atom, a saturated or unsaturated aliphatic hydrocarbon group having a carbon number of 1 to 10 that may contain substituted groups, or an aromatic hydrocarbon group that may contain substituted groups, X¹ could be identical and could be different, respectively, and is a hydrogen atom, or a saturated or unsaturated aliphatic hydrocarbon group having a carbon number of 1 to 10 that may contain substituted groups, Y is an alkyloxy group having a carbon number of 1 to 10, each of n and m represents an integer of 1 to 3, and M¹ is H, Li, Na, K, or Cs.)

Herein, each of R¹ and R³ is a single bond, a saturated or unsaturated aliphatic hydrocarbon group or aromatic hydrocarbon group having a carbon number of 1 to 20 (preferably, 1 to 12, and more preferably, 2 to 8). Specifically, for example, a single bond, —CH₂CH₂—, —CH₂CH₂CH₂—, —CH₂CH₂CH₂CH₂CH₂CH₂—, —CH₂CH₂SCH₂CH₂—, —CH₂CH₂CH₂SCH₂CH₂CH₂—, —CH₂CH₂NHCH₂CH₂CH₂—, —(CH₂CH₂)₂NCH₂CH₂CH₂—, —C₆H₄C₆H₄—, —CH₂C₆H₄CH₂—, —CH₂CH₂CH₂CH₂CH₂CH₂CH₂CH₂CH₂CH₂—, —CH₂CH₂OCONHCH₂CH₂CH₂—, —CH₂CH₂NHCONHCH₂CH₂CH₂—, —(CH₂CH₂)₂CHOCONHCH₂CH₂CH₂—, and the like can be listed.

Further, R² is a hydrogen atom, a saturated or unsaturated aliphatic hydrocarbon group having a carbon number of 1 to 20 (preferably, 2 to 8) that may contain substituted groups, or an aromatic hydrocarbon group that may contain substituted groups. Specifically, for example, CH₃—, C₂H₅—, n-C₃H₇—, CH₂═CHCH₂—, n-C₄H₉—, C₆H₅—, C₆H₁₁—, and the like can be listed.

X¹ could be identical and could be different, respectively, is a hydrogen atom, or a saturated or unsaturated aliphatic hydrocarbon group having a carbon number of 1 to 10 (preferably, 1 to 6) that may contain substituted groups. Specifically, for example, H—, CH₃—, C₂H₅—, n-C₃H₇—, i-C₃H₇—, n-C₄H₉—, t-C₄H₉—, and the like can be listed.

Y is an alkyloxy group having a carbon number of 1 to 10 (preferably, 1 to 6), and, for example, CH₃O—, C₂H₅O—, n-C₃H₇O—, i-C₃H₇O—, n-C₄H₉O—, i-C₄H₉O—, t-C₄H₉O—, and the like can be listed.

Each of n and m represents an integer of 1 to 3, and M¹ is H, Li, Na, K, or Cs.

As a specific example of the compounds represented by the general formulas (2) and (3), 6-(3-(triethoxysilyl)propylamino)-1,3,5-triazine-2,4-dithiol monosodium (TES), 6-(3-(triethoxysilyl)propylamino)-1,3,5-triazine-2,4-dithiol, 6-(3-(monomethyldietoxysilyl)propylamino)-1,3,5-triazine-2,4-dithiol monosodium (DES), 6-(3-(dimethylmonoetoxysilyl)propylamino)-1,3,5-triazine-2,4-dithiol monosodium (MES), 6-di-(3-triethoxysilyl)propylamino)-1,3,5-triazine-2,4-dithiol monosodium (BTES), 6-N-cyclohexyl-N-(3-(triethoxysilyl)propylamino)-1,3,5-triazine-2,4-dithiol monosodium, 6-N-benzyl-N-(3-(monomethyldietoxysilyl)propylamino)-1,3,5-triazine-2,4-dithiol monosodium, and the like can be listed.

General Formula (4)

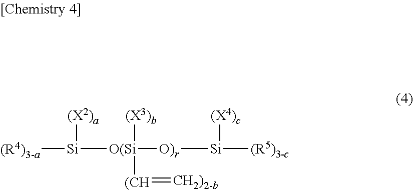

Each of R⁴ and R⁵ could be identical and could be different, and is a saturated or unsaturated aliphatic hydrocarbon group having a carbon number of 1 to 10 (preferably, 1 to 6) that may contain substituted groups or an aromatic hydrocarbon group that may contain substituted groups. Specifically, for example, CH₃—, C₂H₅—, C₃H₇—, C₄H₉—, (CH₃)₂CH—, (CH₃)₃C—, C₆H₅—, —CH₃CH₂CH₂—, and the like can be listed.

Each of X² to X⁴ is a saturated or unsaturated aliphatic hydrocarbon group having a linear or branched carbon chains with a carbon number of 1 to 10 (preferably, 1 to 6) that may contain substituted groups, an aromatic hydrocarbon group that may contain substituted groups, or an alkyloxy group having a carbon number of 1 to 10 (preferably, 1 to 6), and yet at least one of X² and X⁴ is an alkyloxy group.

As a specific example of X² to X⁴, for example, CH₃—, C₂H₅—, C₃H₇—, C₄H₉—, (CH₃)₂CH—, (CH₃)₃C—, C₆H₅—, CF₃CH₂CH₂—, and the like, as well as CH₃O—, n-C₃H₇O—, i-C₃H₇O—, n-C₄H₉O—, i-C₄H₉O—, t-C₄H₉O—, and the like can be listed.

Each of a and c represents an integer of 0 to 3, b represents an integer of 0 to 2, and r represents an integer of 0 to 100.

As a specific example of the compounds represented by the general formula (4), vinyl methoxysiloxane homopolymer, vinyl terminated diethylsiloxane dimethylsiloxane copolymer, vinyl terminated trifluoropropylsiloxane dimethylsiloxane copolymer and the like can be listed.

General Formula (5)

[X⁵_{d}(X⁶O)_{3-d}SiR⁶]_{c}Z (5)

Each of X⁵ and X⁶ could be identical and could be different, and is a saturated or unsaturated aliphatic hydrocarbon group having a carbon number of 1 to 4 (preferably 1 to 2), and CH₃—, C₂H₅— n-C₃H₇—, i-C₃H₇—, CH₂═CHCH₂—, n-C₄H₉—, i-C₄H₉, t-C₄H₉—, and the like can be listed as a specific example.

R⁶ is a bivalent aliphatic hydrocarbon group or aromatic hydrocarbon group having a carbon number of 1 to 18 (preferably, 1 to 12, and more preferably, 2 to 8), and the above aliphatic hydrocarbon group may contain —NH—, —CO—, —O—, —S—, —COO—, or —C₆H₄—. Specifically, —CH₂—, —CH₂(CH₂)_{q-2}CH₂— (q represents an integer of 2 to 18), —C₆H₄—, —CH₂C₆H₄—, —CH₂C₆H₄CH₂—, —CH₂CH₂SCH₂CH₂—, —CH₂CH₂OCH₂CH₂—, —CH₂CH₂OCH₂CH₂OCH₂CH₂—, —CH₂CH₂NHCH₂CH₂—, —CH₂CH₂CH₂NHCH₂CH₂—, —CH₂CH₂OCH₂CH₂OCH₂CH₂OCH₂CH₂—, —(CH₂CH₂)₂NCH₂CH₂CH₂—, —CH₂CH₂CH₂NHCOOCH₂CH₂CH₂—, —CH₂CH₂CH₂NHCONHCH₂CH₂CH₂—, and the like can be listed. Among them, —CH₂(CH₂)_{q-2}CH₂— is preferable, and —CH₂CH₂CH₂— is more preferable.

While Z is —SH, —SCSN(CH₃)₂, —SSCSN(CH₃)₂, —SCSN(C₂H₅)₂, —SCSN(C₄H₉)₂, —SCSN(C₈H₁₇)₂, —SS—, —SSS—, —SSSS—,

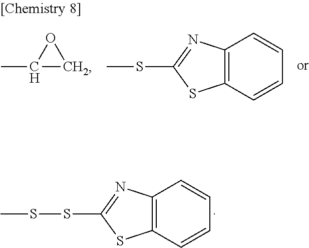

Among them, —SH, —SS—, —SSS—, and —SSSS— are preferable from a viewpoint of crosslinkability to the rubber.

While d is 0, 1 or 2, 0 or 1 is preferable and 0 is more preferable from a viewpoint of reactivity to the board. e is 1 or 2.

As a specific example of the molecular adhesives of the present invention represented by the general formula (5), for example, bis(triethoxysilylpropyl)tetrasulfide, 3-mercaptopropyltrimethoxysilane, 3-mercaptopropylmethyldimethoxysilane and the like can be listed.

H₂N—R⁷—SiX¹₃₋ₙYₙ (6)

In the formula, R⁷ is a saturated or unsaturated aliphatic hydrocarbon group having a carbon number of 1 to 20 (preferably, 2 to 12) that may contain substituted groups, or an aromatic hydrocarbon group that may contain substituted groups, and —CH₂CH₂—, —CH₂CH₂CH₂—, —CH₂CH₂CH₂CH₂CH₂CH₂—, —C₆H₄—, —C₆H₄C₆H₄—, —CH₂C₆H₄CH₂—, —CH₂CH₂CH₂CH₂CH₂CH₂CH₂CH₂CH₂CH₂—, —CH═CH—C(CH₃)₂OCH₂CH₂CH₂—, —CH₂CH₂—NH—CH₂CH₂CH₂—, —(CH₂)₆—NH—CH₂CH₂CH₂—, and the like can be listed.

Each of X¹, Y, and n is similar to the foregoing.

As a specific example of the molecular adhesives represented by the general formula (6) that is used in the present invention, 3-aminopropyltriethxysilane, 3-(3-aminopropoxy)-3,3-dimethyl-1-propenyltrimethoxysilane, and the like, for example, can be listed.

The molecular adhesives represented by the above-mentioned general formulas (2) to (6) may be used alone or in combination of two or more.

When the molecular adhesives represented by the general formula (5) are used,

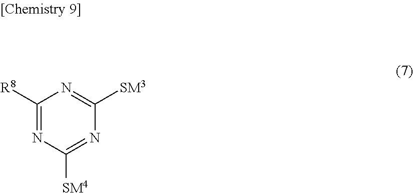

Triazine compounds represented by the general formula (7) are preferably used together with the above molecular adhesives from a viewpoint of the bonding strength.

R⁸ is —OR⁹, —NR¹⁰R¹¹, or —SM².

R⁹ is an alkyl group having a carbon number of 1 to 4, and any alkyl group having a carbon number of 1 to 4, which is described in this specification, may be used.

Each of R¹⁰ and R¹¹ could be identical and could be different, R¹⁰ and R¹¹ may be linked, and each of R¹⁰ and R¹¹ is H, or is an alkyl group, an alkylene group, or an alkenyl group each of which has a carbon number of 1 to 4, or a phenylene group. Further, the alkylene group may contain —NH—, —CO—, —O—, —S—, or —COO—. Specifically, groups similar to ones described in this specification can be listed.

As a specific example of —NR¹⁰R¹¹ in the case that R¹⁰ and R¹¹ are linked, the following ones etc. can be listed.

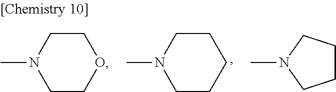

Each of M² to M⁴ could be identical and could be different, and is alkali metal or H, and Li, Na, K, Cs, and the like can be listed as the alkali metal.

As a specific example of the triazine compounds represented by the general formula (7), for example, 1,3,5-triazine-2,4,6-trithiol, 1,3,5-triazine-2-dibutylamino-4,6-dithiol, 1,3,5-triazine-2-diallylamino-4,6-dithiol, and the like can be listed.

As a mixing ratio of the molecular adhesive of the present invention represented by the general formula (5) and the triazine compound represented by the general formula (7), the molecular adhesive: the triazine compound=1:10 to 10:1 (molecular ratio) is preferable, and 1:5 to 5:1 (molecular ratio) is more preferable. The above mixing ratio is preferable because keeping the mixing ratio within the foregoing range makes it possible to realize higher bonding strength at the moment of bonding the board partners.

While the thickness of the molecular adhesive layer is not particularly limited, the thickness of 1×10⁻⁴ to 1×10² μm is preferable, and the thickness of 1×10⁻³ to 1×10² μm is more preferable. When the thickness of the molecular adhesive layer exceeds 1×10² μm, the adhesiveness is inclined to lower.

The molecular adhesives to be used in the present invention, namely, the molecular adhesives represented by the above-mentioned general formula (1), particularly, the molecular adhesives represented by the general formulas (2) to (6) are chemically linkable to the OH groups of the board surface owing to an alkoxysilyl group, and further, contain various functional groups, thereby, making it possible to have the crosslinking reaction to the entropy elastomers. Thus, the above molecular adhesives enables the bonding between the different materials of the entropy elastomer layer to be later described and the board, and the laminated body of the present invention having two layers or more of such molecular adhesive layers can assume a configuration of interposing the entropy elastomer therebetween, thereby making it possible to solve, all at once, an improvement in the adhesiveness to the board of which the surface roughness is large, the alleviation of the stress concentration, an improvement in the reliability, the high adhesiveness (especially, that of a conductor layer), the heat resistance, and the universality (being adherable irrespective of a type of adherends), each of which is regarded as a task at the time of manufacturing the laminated body.

2.2 The Entropy Elastomer Layer

The so-called “entropy elastomer layer” to be used in the present invention is a layer to be comprised of the entropy elastomer, and yet a layer to be formed of the entropy elastomer composition containing the polymer materials of which a glass transition point is lower than the temperature at the time of forming the laminated body (for example, 15 to 200° C.). As the entropy elastomer, the plastics that comes into a rubbery state in the temperature at the time of forming the laminated body, namely, the plastics of which the glass transition point is lower than the temperature at the time of forming the laminated body are included together with the rubbers such as the so-called natural rubbers and synthetic rubbers. Among them, the rubbers, polyethylene and the like, which have the glass transition point lower than a room temperature and are in a rubbery state in a room temperature are preferable. Specifically, for example, copolymer and terpolymer such as natural rubber, 1,4-cisbutadiene rubber (BR), isoprene rubber, polychloroprene, styrene-butadiene copolymer rubber, hydrogenated styrene-butadiene copolymer rubber, acrylnitrile-butadiene copolymer rubber (NBR), hydrogenated acrylnitrile-butadiene copolymer rubber, polybutene, polyisobutylene, ethylene-propylene rubber, ethylene-propylene-diene rubber (EPDM), ethyleneoxides-epichlorohydrin copolymer, polyethylene, polypropylene, polyamide, chlorinated polyethylene, chlorosulfonated polyethylene, alkylated chlorosulfonated polyethylene, chloroprene rubber, chlorinated acryl rubber, brominated acryl rubber, fluorine rubber (FKM), epichlorohydrin rubber (CHR), epichlorohydrin and copolymer rubber thereof, chlorinated ethylene propylene rubber, chlorinated buthyl rubber, brominated buthyl rubber tetrafluorethylene, Teflon (Registered Trademark), hexafluor propylene and vinylidene fluoride, acryl rubber, ethylene acryl rubber, silicone resin, fluorinated silicone rubber, peroxide type silicone rubber, addition type silicone rubber, condensation type silicone rubber, epoxy rubber, urethane rubber, elastomers containing unsaturated groups at both terminals, and the like can be listed. Among them, 1,4-cisbutadiene rubber (BR), acrylnitrile-butadiene copolymer rubber (NBR), ethylene-propylene-diene rubber (EPDM), fluorine rubber (FKM), epichlorohydrin rubber (CHR), fluorinated silicone rubber, peroxide type silicone rubber, addition type silicone rubber, condensation type silicone rubber, and polyethylene are preferable.

In addition, the entropy elastomer composition may contain one kind or more selected from crosslinking agents, crosslinking accelerators, vulcanizing agents, vulcanization accelerators, fillers, metal activating agents, and metal catalysts. Further, the entropy elastomer composition may contain one kind or more selected from stabilizers, softeners, colorants, and ultraviolent light absorbers.

As the crosslinking agent, for example, sulfur, peroxide, triazinethiols, tetramethylthiuramtetrasulfide, dithiomorpholines, and the like can be listed. More specifically, triazinetrithiol, 2-dibutylamino-1,3,5-triazine-4,6-dithiol, ethylenethiourea, bisphenol A, sulfur, colloidal sulfur, oxides such as dicumylperoxide, di-t-butylperoxide, 2,5-dimethyl-2,5-di(t-butylperoxy)hexane, 2,5-dimethyl-2,5-di(t-butylperoxy)hexine-3, and di(t-butylperoxyisopropyl)benzene, benzoquinonedioxime, saligen, dimethylol-phenol, and the like can be listed, and these may be used alone or in combination of two or more.

As a mixing amount of the crosslinking agent, the mixing amount of 0.1 to 10 parts by weight per 100 parts by weight of the polymer material is preferable, and the mixing amount of 0.5 to 5 parts by weight is more preferable.

As the crosslinking accelerator, sulfeneamides, mercaptobenzothiazoles, thiurams, guanamines, and multi-functional monomers and the like can be listed. More specifically, thiazole type accelerators such as dibenzothiazoyl disulfide and 4-morpholinodithiobenzothiazole, sulphenic amide type accelerators such as N-cyclohexyl-2-benzothiazoyl sulphenic amide, N-t-butyl-2-benzothiazoyl sulphenic amide, N-oxydiethylene-2-benzothiazoyl sulphenic amide, N-diisopropyl-2-benzothiazoyl sulphenic amide, N-dicyclohexyl-2-benzothiazoyl sulphenic amide, and thiuram type accelerators such as tetramethyl thiuram disulfide, tetraethyl thiuram disulfide, tetrabutyl thiuram disulfide, tetraoctyl thiuram disulfide and dipentamethylene thiuram tetrasulfide, and multifunctional monomers such as triallyl isocyanate, triallyl oxytriazine, ethyleneglycol diacrylate, pentaerythritol tetramethacrylate, and the like can be listed, and these may be used alone or in combination of two or more.

As a mixing amount of the crosslinking accelerator, the mixing amount of 0.01 to 20 parts by weight per 100 parts by weight of the polymer material is preferable, and the mixing amount of 0.1 to 10 parts by weight is more preferable.

The fillers are added for a purpose of enhancing the strength of the entropy elastomer layer and increasing the amount. As the filler, the fillers such as carbon blacks of various grades such as HAF and FEF, calcium carbonate, talc, clay, kaolin, glass and fumed and baked silica, and the fibers and clothes such as rayon, nylon, polyester, vinylon, steel, Kevlar fiber (Registered Trademark of Du Pont), carbon fibers, and glass fibers can be listed, and these may be used alone or in combination of two or more.

As a mixing amount of the filler, the mixing amount of 0 to 200 parts by weight per 100 parts by weight of the polymer material is preferable, and the mixing amount of 10 to 100 parts by weight is more preferable.

The metal activating agents are added for a purpose of regulating a crosslinking speed, and accepting acid. As the metal activating agents, zinc oxide, magnesium oxide, calcium oxide, barium oxide, aluminum oxide, tin oxide, iron oxide, calcium hydroxide, calcium carbonate, magnesium carbonate, fatty acid sodium, calcium octylate, potassium isooctylate, potassium butoxide, cesium octylate, potassium isostearate and the like can be listed, and these may be used alone or in combination of two or more.

As a mixing amount of the metal activating agent, which is not particularly limited, the mixing amount of 0 to 20 parts by weight per 100 parts by weight of the polymer material is preferable, and the mixing amount of 1 to 10 parts by weight is more preferable.

The entropy elastomer layer to be used in the present invention may be multilayered after preparing the foregoing entropy elastomer composition, and molding the above composition in a desired form (for example, a sheet form), and further, the un-crosslinked entropy elastomer composition may be multilayered without special molding.

The method of preparing the entropy elastomer composition is not particularly limited, and the entropy elastomer composition may be prepared with the method in use for the usual rubber compounds, and may be prepared by mixing it, for example, with an open roll, a banbury mixer, a kneader, and the like.

Further, the condition of the crosslinking is not particularly limited, and the condition that is adopted for the usual rubber compounds may be used.

3. The Method of Manufacturing the Laminated Body

The method of manufacturing the laminated body of the present invention is not particularly limited, and any method may be used so long as it is a method of forming the elastic molecular bonding layer between the two boards.

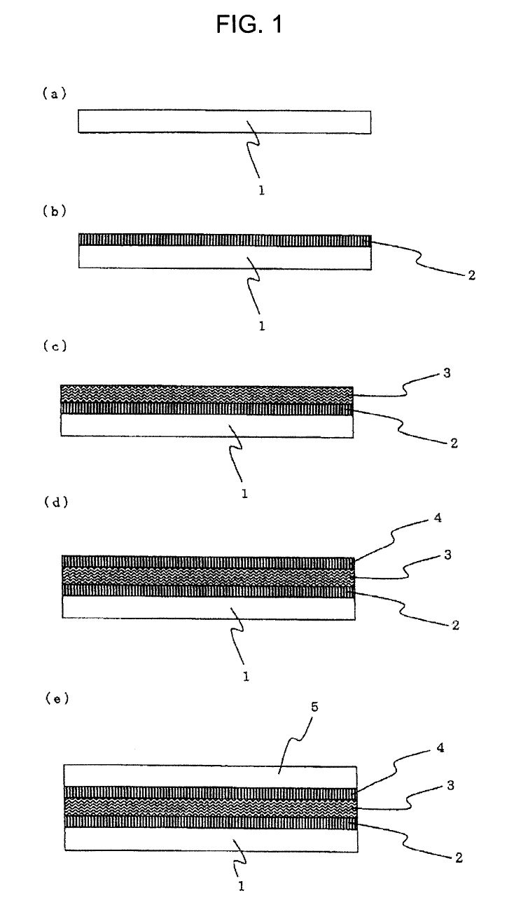

For example, as shown in FIG. 1, the method (FIG. 1 (e)) may be employed of forming the laminated body by forming (FIG. 1 (b)) the molecular adhesive layer 1 (2) on the board 1 (1) (FIG. 1 (a)), multilayering (FIG. 1 (c)) the entropy elastomer layer 1 (3) on the above molecular adhesive layer 1 (2), furthermore multilayering (FIG. 1 (d)) the molecular adhesive layer 2 (4) on the above entropy elastomer layer 1 (3), and, in addition, multilayering the board 2 (5). This method is referred to as a cumulative technique in the present invention.

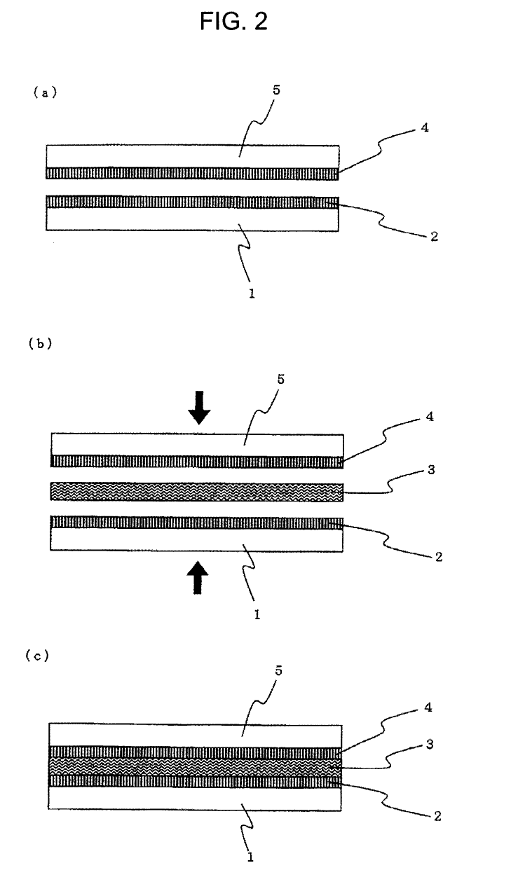

Further, as shown in FIG. 2, the method (FIGS. 2 (b) and (c)) may be employed of forming the laminated body by previously forming (FIG. 2 (a)) the molecular adhesive layer 1 (2) and the molecular adhesive layer 2 (4) on respective surfaces of the board 1 (1) and the board 2 (5), and interposing the entropy elastomer layer 1 (3) between the two boards each having the above molecular adhesive layers 1 and 2 formed thereon. This method is referred to as a sandwich technique.

While these methods may be appropriately selected depending upon a shape etc. of the laminated body, being a target, for example, when one board, out of the two boards, is formed by the electroless plating and the like, the cumulative technique is preferably used.

Hereinafter, these methods will be explained.

3.1 The Cumulative Technique

(1) A Pretreatment Method of the Board

In the present invention, reacting OH groups existing on the board surface with the molecular adhesive enables the molecular adhesive layer to be formed.

Thus, the board surface needs to have —OH groups, and when the board having no —OH group on the surface thereof is used, the —OH groups need to be introduced with the pretreatment. Further, the board may be subjected to the pretreatment so as to enhance the reactivity with the molecular adhesive even though it has the —OH groups.

As the pretreatment method, a corona discharge treatment, an atmospheric pressure plasma treatment, a ultra-violet irradiation treatment, and the like can be listed.

As the pretreatment method, the publicly known methods may be employed, and for example, the method described in “Corona Discharge Treatment” in Journal of the Adhesion Society of Japan, Vol. 36, No. 3, 126 (2000) with regard to the corona discharge treatment, and the method described in “Plasma Treatment” in Journal of the Adhesion Society of Japan, Vol. 41, No. 14 (2005) with regard to the atmospheric pressure plasma treatment can be preferredly employed. Many —OH groups, —COOH groups, —C═O groups, and the like are generated in the solid surface, or appears in the surface owing to these treatments (see L. J. Gerenser: J. Adhesion Sci. Technol. 7, 1019 (1997)).

As a rule, the solid surface absorbs dust elements in the air and is contaminated, and performing the pretreatments as described above also makes it possible to generate the —OH groups on the surface simultaneously with the cleaning.

The corona discharge treatment may be performed under a condition of a power source: AC 100 V, an output voltage: 0 to 20 kV, an oscillation frequency: 0 to 40 kHz for 1 to 60 seconds, and a temperature of 0 to 60° C. by employing a corona surface reforming device (for example, Corona Master made by Shinko Electric & Instrumentation Co., Ltd.)

The atmospheric pressure plasma treatment may be performed under a condition of a plasma treatment speed 10 to 100 mm/s, a power source: 200 V or 220 V AC (30A), compressed air: 0.5 MPa (1 NL/min), 10 kHz/300 W to 5 GHz, power: 100 W to 400 W, and an irradiation time: 0.1 to 60 seconds by employing an atmospheric pressure plasma generator (for example, Aiplasuma made by Panasonic Electric works).

The UV irradiation may be performed under a condition of a wavelength: 200 to 400 nm, a power source: 100 V AC, a peak illuminance of a light source: 400 to 3000 mW/cm², and an irradiation time: 1 to 60 seconds by employing a UV-LED irradiation device (for example, ZUV-C30H Smart Curing LED system made by OMRON Corporation).

(2) A Method of Forming the Molecular Adhesive Layer 1

The method of forming the molecular adhesive layer 1 on the board having OH groups is not particularly limited, and the publicly-known methods may be employed. For example, the methods by immersion, coating, spraying and the like can be listed, and the method by the immersion is preferable from a viewpoint of being capable of uniformly coming into contact with the foregoing solutions.

The immersion method may be performed by immersing the board into the molecular adhesive solution, heating and drying it.

The concentration of the molecular adhesive is not particularly limited, and may be appropriately selected, and for example, the concentration of 5×10⁻³ to 5% by weight is preferable, and the concentration of 0.01 to 1% by weight is more preferable. The above concentration is preferable because setting the concentration within the foregoing range leads to an increase in the bonding strength. Further, the solvents are not particularly limited, and alcohols such as methanol, ethanol, isopropanol, ethylene glycol and diethylene glycol, ketones such as acetone and methyl ethyl ketone, esters such as ethyl acetates, halides such as chloride ethylene, olefins such as buthane and hexane, ethers such as tetrahydrofuran and butylether, aromatics such as benzene and toluene, amides such as dimethylformamide and methylpyrrolidone, water, mixed solvents thereof, and the like, for example, can be listed.

The immersion treatment conditions are not particularly limited, and for example, the condition of the immersion for 1 second to 60 minutes at a temperature of 0 to 100° C. is preferable. The immersion condition, which is governed by the temperature, the time, and the concentration of the solutions, is not uniquely decided, and the immersion condition has a tendency that the time is longer when the temperature is lower at a constant concentration, and further, the time is shorter when the temperature is higher at a constant concentration.

Further, as a heating condition, the condition of the heating for 1 second to 120 minutes at a temperature of 20 to 250° C. is preferable, the condition of the heating for 1 to 60 minutes at a temperature of 50 to 200° C. is more preferable, and yet the condition of the heating for 1 to 30 minutes at a temperature of 80 to 180° C. is preferable. Keeping the heating condition within this range is preferable from an economical viewpoint because the above condition yields a high productivity.

The heating methods are not particularly limited, the publicly-known methods may be employed, and the methods of employing ovens, driers, high-frequency heaters, and the like, for example, can be listed.

Additionally, when the reaction between the molecular adhesive solution and the board is insufficient, the above contact and heating may be repeated one time to ten times, or so. That is, the way of shortening a one-time contact time and heating time and increasing the number of times of the reactions is effective in some cases.

Further, the formation of the molecular adhesive layer on one part of the board may be also carried out appropriately responding to the application of the laminated body. The methods of forming the molecular adhesive layer on one part of the board are not particularly limited, and for example, the method by protection of one part of the board by means of the masking, the method by decomposition of the molecular adhesive by means of the exposure utilizing the mask, and the like can be listed.

(3) A Method of Forming the Entropy Elastomer Layer

The entropy elastomer layer can be formed by bringing un-crosslinked or crosslinked entropy elastomer composition in contact with all surface or one part of the surface of the molecular adhesive layer 1 formed on the board, and bonding them together under a pressure, by heat, and/or by an optical medium.

Herein, the so-called one part signifies that when the surface of the limited one part of the molecular adhesive layer 1 has been subjected to the activation treatment for the bonding reaction, the entropy elastomer layer is formed only on the part subjected to the above activation treatment responding to applications of the laminated body.

As the so-called activation treatment, for example, the treatment of reacting alkali metals in order to enhance the reactivity of a thiol group to be contained in the molecular adhesive, the treatment of furthermore reacting the function groups by use of the exposure method utilizing the mask, and the like can be listed.

As mention before, as the method of forming the entropy elastomer layer, the method may be used of preparing the foregoing entropy elastomer composition and previously molding the above composition in a desired shape (for example, a sheet form), and then bringing this molded product in contact to the molecular adhesive layer.

The so-called contact in the present invention signifies that a status in which un-crosslinked or crosslinked entropy elastomer composition and all surface or one part of the molecular adhesive layer 1 formed on the board have been pasted together is brought about.

The contact may be carried out under a depressurized or pressurized condition at the moment of bring both in contact to each other for a purpose of bring about a status in which both have been pasted together. The depressurized condition and the pressurized condition are not particularly limited, and may be set appropriately. However, under a condition as near as possible to the atmosphere, there is a tendency that the adhesiveness to the board deteriorates and further, the physical property of the entropy elastomer lowers, and under a condition in which the pressure is extremely high, there is a tendency that the board is broken, the thickness of the entropy elastomer layer becomes thin, and thus, the entropy elastomer layer has no sufficient function.

When both are bonded by accelerating the reaction of the interface by the heat, the bonded product is preferably obtained by heating the interface for 0.1 to 1440 minutes (preferably, 1 to 720 minutes) at a temperature of 0 to 300° C. (preferably, 20 to 200° C.). As a heating method, ovens, driers, high-frequency heaters, and the like can be listed.

When both are bonded by the optical medium, bonded products is preferably obtained by irradiating the interface for 1 to 180 minutes (preferably, 2 to 90 minutes) in 200 to 450 nm (preferably, 254 to 365 nm). As the optical medium, the ultra-violent irradiation device using the light sources such as mercury lamps (a wavelength: 254 nm, 303 nm, 313 nm, and 365 nm), metal halide lamps (200 to 450 nm), and hyper-metal halide lamps (400 to 450 nm), and the like can be listed.

The bonding of the entropy elastomer layer may be carried out by either the heat or the optical medium, and can be also carried out by employing both of these methods.

The molecular adhesive layer 1 and the entropy elastomer layer formed on the board 1 are chemically linked to each other by the crosslinking reaction, thereby making it possible to provide the laminated body having an excellent adhesiveness.

(4) A Method of Forming the Molecular Adhesive Layer 2

The methods of forming the molecular adhesive layer 2 on the entropy elastomer layer are not particularly limited, and the molecular adhesive and the entropy elastomer layer can be also chemically linked to each other by the crosslinking reaction therebetween, and the molecular adhesive layer 2 can be also formed by reacting the OH groups of the entropy elastomer layer with the molecular adhesive, similarly to the foregoing.

Forming the molecular adhesive layer 2 by reacting the OH groups of the entropy elastomer layer with the molecular adhesive requires that the —OH groups should be present on the surface of the entropy elastomer layer, and employing the entropy elastomer layer having no —OH group on the surface thereof requires that the —OH group should be previously introduced by the pretreatment. Further, for the entropy elastomer layer having the —OH group on the surface thereof as well, the pretreatment may be performed in order to enhance the reactivity with the molecular adhesive.

As the pretreatment method, the methods similar to the pretreatment methods of the board can be listed.

The method of forming the molecular adhesive layer 2 is similar to the method of forming the molecular adhesive layer 1.

Each of the molecular adhesive layers 1 and 2 may employ an identical molecular adhesive, and further, may employ a different molecular adhesive.

(5) A Method of Forming the Laminated Body

For example, multilayering the board 2 on the surface on which the board 1, the molecular adhesive layer 1, the entropy elastomer layer and the molecular adhesive layer 2 have been multilayered in this order makes it possible to obtain the laminated body of the present invention. Additionally, with the case that the board 2 is a metal plate or a resin plate, it is preferable from a viewpoint of the adhesiveness to perform the pretreatment of giving the functional group that reacts to the molecular adhesive constituting the molecular adhesive layer 2 to the board 2 at this moment.

Further, the board 2 may be formed with the plating method.

The plating method is not particularly limited, and the electroless plating method or the electrochemical plating method may be used.

Specifically, the electroless plating layer is formed on the molecular adhesive layer 2 by supporting the catalyst, being a nucleus, on the molecular adhesive layer 2, and performing the electroless plating with the above plating catalyst as a nucleus. Further, the electrochemical plating may be performed on the electroless plating layer in addition.

The catalysis is not particularly limited, and any catalyst may be used so long as it is usually used for the electroless plating. Specifically, palladium/Sn colloid, Ag complexes, Pd complexes, and the like can be listed.

The plating layer is not particularly limited, and for example, when the stress should be alleviated all the more, copper is utilized, and when the metal surface should be hardened, nickel is utilized, appropriately. The board 2 may be formed on all surface of the molecular adhesive layer 2, or may be formed on one part of the molecular adhesive layer 2. Herein, the so-called one part is similar to the foregoing. Additionally, when the board 2 is formed by the plating method, 6-(3-(triethoxysilyl)propylamino)-1,3,5-triazine-2,4-dithiol monosodium (TES) is preferable as the molecular adhesive constituting the molecular adhesive layer 2.

3.2 The Sandwiching Technique

(1) A Method of Forming the Molecular Adhesive Layer

The molecular adhesive layer 1 and the molecular adhesive layer 2 are previously formed on respective surfaces of the board 1 and the board 2. As a forming method, the method similar to the case of the cumulative technique may be adopted.

(2) The Sandwiching Method

Interposing the entropy elastomer layer between the surfaces of the two boards each having the above molecular adhesive layer formed thereon makes it possible to form the laminated body.

Specifically, multilayering the board 1 having the molecular adhesive layer 1 formed thereon and the board 2 having the molecular adhesive layer 2 formed thereon, and the entropy elastomer layer allows the laminated body to be formed under a depressurized or pressurized condition. The depressurized/pressurized condition is not particularly limited, and may be appropriately set.

4. A Shape of the Laminated Body

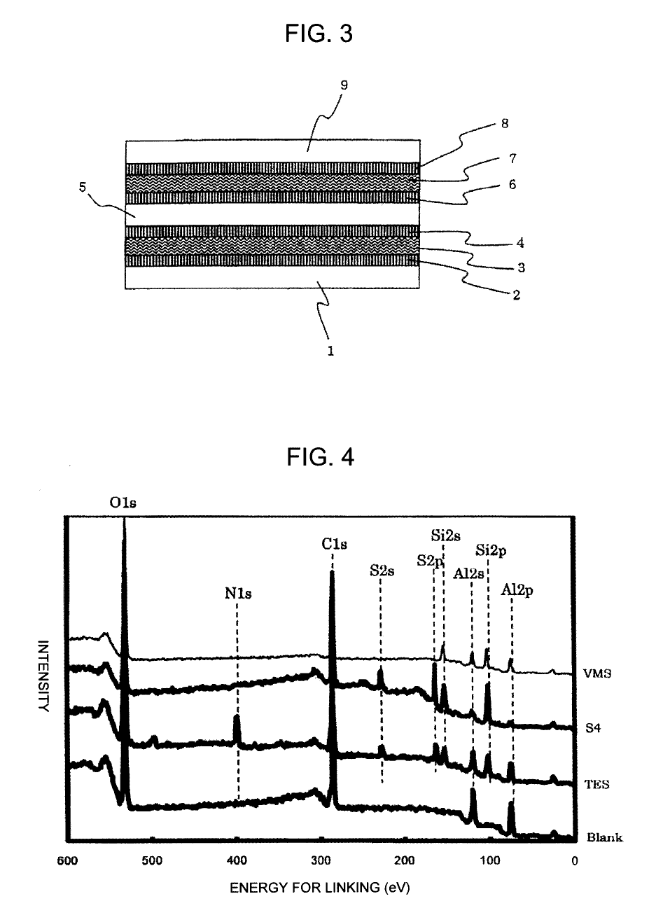

The present invention, as shown in FIG. 1 and FIG. 2, relates to the laminated body manufactured by forming the entropy elastic molecular bonding layer between the two boards of the board 1 and the board 2, and is characterized in that the above elastic molecular bonding layer is composed of the entropy elastomer layer 1 and the molecular adhesive layers 1 and 2. For example, as shown in FIG. 3, another board can be also bonded furthermore onto the laminated body of FIG. 1 and FIG. 2 via the entropy elastic molecular bonding layer. Specifically, as shown in FIG. 3, the molecular adhesive layer 3, the entropy elastomer layer 2, the molecular adhesive layer 4, and the board 3 are furthermore formed on the laminated bodies of FIG. 1 and FIG. 2, and the like.

Further, as a forming method, the methods described in this specification may be adopted, and the boards can be multilayered in many layers so long they are multilayered via the elastic bonding layer.

The laminated body of the present invention can be preferredly used for the electronic mounting parts, the precise machining parts, the building strictures, the circuit wiring boards, the decorative plating commodities, and bonded complex commodities.

### EXEMPLARY EXAMPLE

Hereinafter, while the test examples and the exemplary examples are listed for explaining the present invention, the present invention is not limited to these exemplary examples.

### Exemplary Example 1

### Manufacturing a Board (I) Subjected to a Hydroxylation Treatment

The board (I) subjected to the hydroxylation treatment is manufactured by using an aluminum plate (1×30×50 mm, made of the Nilaco corporation, and hereinafter, sometimes referred to as “Al”) as the board, and performing the corona discharge treatment of which a number of roundtrips is three with an output power of 13 kW at a speed of 2 m/minute using the corona discharging apparatus made by Kasuga electric works Ltd).

### Manufacturing the Board Having the Molecular Adhesive Linked Hereto (II)

The board (II) having the molecular adhesive (TES) linked hereto was obtained by immersing the obtained board (I) in a 95% water/ethanol (0.2% by weight) solution of 6-(3-(triethoxysilyl)propylamino)-1,3,5-triazine-2,4-dithiol monosodium (TES) for five minutes, thereafter heating it in the oven for 10 minutes at a temperature of 150° C., and performing the ethanol cleaning/dryer drying.

### Manufacturing the Bonded Product (III) of the Board and the EPDM Elastomer

The bonded product (III) (the thickness of the elastomer is approximately 1.2 mm) of the board and the EPDM elastomer was obtained by pasting together the sheet (thickness is approximately 1.5 mm) of the entropy elastomer composition (1) shown in the following Table 8 and the molecular adhesive layer forming surface of the obtained board (II), and heating them for 10 minutes at a temperature of 160° C. and under a pressure of 5 MPa.

### Manufacturing the Board Having the EPDM Elastomer Bonded Thereon (IV)

The board having the EPDM elastomer bonded thereon (IV) to which the molecular adhesive (TES) was linked was obtained by subjecting the EPDM surface of the obtained boded product (III) to the corona discharge treatment likewise, immersing it in a 95% water/ethanol (0.2% by weight) solution of the TES for five minutes, thereafter heating it in the oven for 10 minutes at a temperature of 150° C. and performing the ethanol cleaning/the dryer drying.

### Manufacturing a Laminated Body (V)

The catalysis support was carried out by immersing the obtained board (IV) in a Pd/Sn colloidal catalyst (CATAPOSIT 44 made by Rohm and Haas Company) solution for five minutes, and washing in water, and thereafter, immersing it in an accelerator (ACCELERATOR-19E made by Rohm and Haas Company) solution for seven minutes, washing in water, and thereafter drying.

The laminated body (V) having the copper plating layer (hereinafter, sometimes referred to as “copper plating”) with a thickness of approximately 40 μm was obtained by subjecting the board to the electroless plating by immersing it in an electroless copper plating bath for 10 minutes at a temperature of 30° C., and furthermore supplying the electric current in the electric copper plating bath for 60 minutes at a temperature of 30° C. after the catalysis support.

### Exemplary Example 2

The laminated body (V) was obtained similarly to the exemplary example 1 except that an alumina board (30×50×3 mm, hereinafter, sometimes referred to as “alumina”) was used as the board instead of the aluminum plate.

### Exemplary Example 3

The laminated body (V) was obtained similarly to the exemplary example 1 except that a glass epoxy resin plate (0.2×30×50 mm, FR-4; made by Panasonic Electric works and hereinafter, sometimes referred to as “EP”) was used as the board instead of the aluminum plate.

### Exemplary Example 4

The laminated body (V) was obtained similarly to the exemplary example 1 except that a polyimide resin plate (0.05×30×50 mm, kapton; made by Toray industries Inc./E. I. du Pont de Nemours and Company, and hereinafter, sometimes referred to as “PI) was used as the board instead of the aluminum plate.

### Comparative Exemplary Examples 1 to 4

The laminated bodies were obtained by using the boards shown in Table 1 and performing a treatment similar to the treatment of the exemplary example 1 except that the TES treatment was not performed.

<TES Linkage Confirmation>

Confirmation of the linkage between the board and the TES, and confirmation of the linkage between the EPDM elastomer and the TES was confirmed by measuring all elements with X-ray Photoelectron Spectroscopy XPS (Perkin Elmer PHI5600ESCA system made by ULVAC-PHI) after forming the TES layer on the board, and after forming the TES layer on the EPDM elastomer layer, respectively.

As a result, it became clear from a result of the XPS measurement that existence of an S2p peak based upon sulfur atoms originating in the TES was observed and the board and the TES were linked when performing the TES treatment for four kinds of the boards of the metal (aluminum), the ceramics (Al₂O₃), the resin (EP and PI), and the like after the corona discharge treatment (see FIG. 4). As a comparative experiment, no sulfur atom was detected at all even though the TES treatment was performed for various boards not subjected to the corona discharge treatment similarly to the exemplary example 1.

Further, when the EPDM surface of the bonded product (III) was subjected to the corona discharge treatment and then the TES treatment, the sulfur atoms were observed on the surface all the same. As a comparative experiment, when the TES treatment was performed without the EPDM surface of the bonded product (III) subjected to the corona discharge treatment, no existence of the sulfur atoms was detected.

<A Method of Measuring the Strength>

1) The Adhesiveness of the EPDM Elastomer Layer

The peel strength of the bonded product (III) was measured by notching the EPDM elastomer layer of the bonded product (III) of the board and the EPDM elastomer at a width of one cm, and peeling it at a speed of 50 mm/minute with a tensile testing machine (Autograph P-100 made by Shimadzu Corporation).

2) The Adhesiveness of the Conductor Layer

The conductor layer (copper plating layer) of the laminated body (V) was evaluated with the peel strength using a method similar to the method described before.

A result thereof is shown in Table 1.

TABLE 1

| | | | Peel strength (kN/m) | |
|---|---|---|---|---|
| | | | Adhesiveness | |
| | | TES | of EPDM | Adhesiveness of |
| | Board | treatment | elastomer layer | conductor layer |
| Example 1 | Al | With | 6.2 | 2.9 |
| Example 2 | Alumina | | 5.9 | 2.8 |
| Example 3 | EP | | 6.5 | 2.8 |
| Example 4 | PI | | 5.9 | 3.1 |
| Comparative | Al | Without | 0.2 | 0 |
| example 1 | | | | |
| Comparative | Alumina | | 0.1 | 0 |
| example 2 | | | | |
| Comparative | EP | | 0.2 | 0 |
| example 3 | | | | |
| Comparative | PI | | 0.2 | 0 |
| example 4 | | | | |

As apparent from a result of Table 1, it became known that when the EPDM elastomer composition and the board having the TES linked hereto were pasted together, the breakage of all of the EPDM layers was observed, and the EPDM elastomer was bonded onto the board at the high peel strength. Further, it became known that when the copper plating layer was formed on the board having the EPDM elastomer bonded hereon, which was subjected to the TES treatment, the copper plating layer was bonded at the high peel strength all the same.

### Exemplary Example 5

### Manufacturing a Board (I) Subjected to the Hydroxylation Treatment

The copper board (I-1) subjected to the hydroxylation treatment and the copper foil (I-2) subjected to the hydroxylation treatment were manufactured by using a copper plate (1×30×50 mm, made of the Nilaco corporation) and a copper foil (0.1×30×50 mm, made of the Nilaco corporation) as the board, and performing the corona discharge treatment of which a number of roundtrips is three with an output power of 13 kW at a speed of 2 m/minute by using the corona discharging apparatus made by Kasuga electric works Ltd.

### Manufacturing the Board Having the Molecular Adhesive Linked Hereto (II)

The board having the molecular adhesive (VMS) linked hereto (II-1) was obtained by immersing the obtained copper board (I-1) subjected to the hydroxylation treatment in a 95% water/ethanol (0.2% by weight) solution of vinylmethoxysiloxane homopolymer (VMS made by Gelest Inc.) represented by the following formula for five minutes, thereafter heating it in the oven for 10 minutes at a temperature of 150° C., and performing the ethanol cleaning/dryer drying.

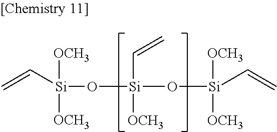

(A degree of polymerization: γ=8.7)

Further, the copper foil (II-2) having the molecular adhesive (VMS) linked hereto was obtained by immersing the obtained copper foil (I-2) subjected to the hydroxylation treatment in a 95% water/ethanol (0.2% by weight) solution of vinylmethoxysiloxane homopolymer (made by Azomax) for five minutes, thereafter heating it in the oven for 10 minutes at a temperature of 120° C., and performing the ethanol cleaning/dryer drying.

### Manufacturing the Sheet of the Entropy Elastomer Composition

The sheet (approximately 2 mm) of the entropy elastomer composition was prepared by molding the entropy elastomer compositions (2) shown in the following Table 8 in a sheet shape.

### Manufacturing the Laminated Body (V)

The laminated body (V) of the board and the copper foil (conductor layer) via the entropy elastomer bonding layer was obtained by degassing the sheet of the entropy elastomer composition (1) and the obtained boards (II-1) and (II-2) under vacuum, pasting them together with the sheet interposed between the VMS linkage surfaces of the boards in a sandwiching manner, and heating them for 12 hours at a temperature of 50° C.

### Exemplary Example 6

The laminated body (V) was obtained similarly to the exemplary example 5 except that a glass plate (2×30×50 mm, made by the Nilaco corporation) (namely, the board was the glass plate and the copper foil) was used as the board instead of the copper plate.

### Exemplary Example 7

The laminated body (V) was obtained similarly to the exemplary example 5 except that a glass epoxy resin plate (EP, 0.2×30×50 mm, FR-4; made by Panasonic Electric works) was used as the board instead of the copper plate.

### Exemplary Example 8

The laminated body (V) was obtained similarly to the exemplary example 5 except that a polyimide resin plate (PI, 0.05×30×50 mm, kapton; made by Toray industries Inc./E. I. du Pont de Nemours and Company) was used as the board instead of the copper plate.

### Comparative Exemplary Examples 5 to 8

The laminated bodies were obtained by using the boards shown in Table 2 instead of the copper plate as the board, and yet performing a treatment similar to the treatment of the exemplary example 5 except that the VMS treatment was not performed.

<VMS Linkage Confirmation>

Both of confirmation of the linkage between the board and the VMS, and confirmation of the linkage between the copper foil and the VMS were carried out by measuring all elements with X-ray Photoelectron Spectroscopy XPS (Perkin Elmer PHI5600ESCA system made by ULVAC-PHI) after the treatment.

As a result, it became clear from a result of the XPS measurement that existence of a Si2p peak based upon silicon atoms originating in the VMS was observed and the board and the VMS were linked when performing the VMS treatment for four kinds of the boards of the metal (copper), the ceramics (glass), and the resin (EP and P1), and the like after the corona discharge treatment (see FIG. 4). As a comparative experiment, the VMS treatment was performed for these boards without the corona discharge treatment; however, no Si atom was detected at that moment.

Further, when the copper foil was subjected to the corona discharge treatment and then the VMS treatment, the Si atoms were observed on the surface thereof all the same. On the other hand, as a comparative experiment, the VMS treatment was performed for the copper foil without the corona discharge treatment; however, no existence of the Si atom was able to be detected at that moment.

<A Method of Measuring the Strength>

The peel strength of the adhesiveness of the board and the copper foil was obtained by notching the bonded product in such a manner that the board was notched at a width of one cm, and peeling it at a speed of 50 mm/minute with a tensile testing machine (Autograph P-100 made by Shimadzu Corporation).

A result thereof is shown in Table 2.

TABLE 2

| | | | Peel |
|---|---|---|---|
| | | VMS | strength |
| | Board | treatment | (kN/m) |
| Example 5 | Copper plate/Copper foil | With | 3.5 |
| Example 6 | Glass plate/Copper foil | | 3.2 |
| Example 7 | EP/Copper foil | | 3.4 |
| Example 8 | PI/Copper foil | | 3.3 |
| Comparative | Copper plate/Copper foil | without | 0 |
| example 5 | | | |
| Comparative | Glass plate/Copper foil | | 0 |
| example 6 | | | |
| Comparative | EP/Copper foil | | 0 |
| example 7 | | | |
| Comparative | PI/Copper foil | | 0 |
| example 8 | | | |

It became known that the breakage of the silicone rubber layer between the board and the copper foil was observed and the elastomer was bonded onto the board and the copper foil at the high peel strength when the board having the VMS linked hereto and the copper foil having the VMS linked hereto were pasted together with the silicone rubber sheet composition interposed therebetween.

### Exemplary Example 9

### Manufacturing the Board (I) Subjected to the Hydroxylation Treatment

The boards (I-1) and (I-2) subjected to the hydroxylation treatment were manufactured by using the aluminum plate (Al, 1×30×50 mm, made of the Nilaco corporation) as the board 1, and a SUS 304 plate (1×30×50 mm, made of the Nilaco corporation, and hereinafter, sometimes referred to as “SUS”) as the board 2, and performing the corona discharge treatment of which a number of roundtrips is three with an output power of 13 kW at a speed of 2 m/minute using the corona discharging apparatus made by Kasuga electric works Ltd.

### Manufacturing the Board Having the Molecular Adhesive (TES) Linked Hereto (II)

The boards each having the molecular adhesive (TES) linked hereto (II-1) and (II-2) were obtained by immersing the obtained boards (I-1) and (I-2) in a 95% water/ethanol (0.2% by weight) solution of 6-(3-(triethoxysilyl)propylamino)-1,3,5-triazine-2,4-dithiol monosodium (TES) for five minutes, thereafter heating them in the oven for ten minutes at a temperature of 150° C., and performing the ethanol cleaning/dryer drying.

### Manufacturing the Entropy Elastomer Composition (3)

A master batch was yielded by adding one part by weight of SRF Black (Asahi #40 made by ASAHI CARBON CO., LTD.) and one part by weight of stearate per 100 parts by weigh of epichlorohydrin rubber (CHR), mixing them for 20 minutes at a temperature of 80° C. with the banbury mixer, and thereafter blending with roll for ten minutes. Next, the entropy elastomer compositions (3) shown in the following Table 8 were obtained by blending one part by weight of ZISNET-F (crosslinking agent made by Sannkyou Kasei) and three parts by weight of magnesium oxide (MgO) on the roll.

### Manufacturing the Laminated Body (V)

The laminated body (V) of the board partners via the entropy elastomer bonding layer was obtained by interposing the sheet of the entropy elastomer composition (3) between the boards (II-1) and (II-2) in a sandwiching manner, and heating them for 30 minutes at a temperature of 160° C. under the pressurization.

### Exemplary Example 10

The laminated body (V) was obtained similarly to the exemplary example 9 except that a glass epoxy resin plate (EP, 0.2×30×50 mm, FR-4 made by Panasonic Electric works) was used as the board 2.

### Exemplary Example 11

The laminated body (V) was obtained similarly to the exemplary example 10 except that a polyamide resin plate (0.5×30×50 mm, 6-nylon sheet made by SK Company, and hereinafter, sometimes referred to as “PA”) was used as the board 1.

### Exemplary Example 12

The laminated body (V) was obtained similarly to the exemplary example 9 except that a glass plate (2×30×50 mm, made by MATSUNANI GLASS IND., LTD.) and an aluminum plate (Al, 1×30×50 mm, made by the Nilaco corporation) were used as the board 1 and the board 2, respectively.

### Exemplary Example 13

The laminated body (V) was obtained similarly to the exemplary example 12 except that a polyamide resin plate (PA, 0.5'30×50 mm, 6-nylon sheet: made by SK Company) was used as the board 2.

### Exemplary Example 14

The laminated body (V) was obtained similarly to the exemplary example 12 except that a glass plate (2×30×50 mm, made by MATSUNANI GLASS IND., LTD.) was used as the board 2.

### Comparative Exemplary Examples 9 to 14

The laminated bodies (V) were obtained by using the boards shown in Table 3 and performing a treatment similar to the treatment of the exemplary example 9 except that the TES treatment was not performed.

### Comparative Exemplary Examples 15 to 20

The laminated bodies (V) were obtained by using the boards shown in Table 3 and performing a treatment similar to the treatment of the exemplary example 9 except that the elastomer was not used.

<TES Linkage Confirmation>

Confirmation of the linkage between the board and the TES was carried out by measuring all elements with X-ray Photoelectron Spectroscopy XPS (Perkin Elmer PHI5600ESCA system made by ULVAC-PHI) after the treatment.

It became clear from a result of the XPS measurement that existence of an S2p peak based upon sulfur atoms originating in the TES was observed and the board and the TES were liked when performing the TES treatment for five kinds of the boards of the metal (Al and SUS), the ceramics (glass), the resin (EP and PA), and the like after the corona discharge treatment. However, no S atom was detected at all in the laminated body (not subjected to the TES treatment) of the comparative exemplary example 3.

<The Method of Measuring the Strength>

The shear/peel strength of the adhesiveness of the board partners was obtained by mounting the entropy elastomer of 1.25 cm×0.6 cm onto the edge of the board of 1.25 cm×5 cm, preparing shear/peel strength test samples, and peeling them at a speed of 50 mm/minute with a tensile testing machine (Autograph P-100 made by Shimadzu Corporation).

A result thereof is shown in Table 3.

TABLE 3

| | | | | Existence of | |
|---|---|---|---|---|---|
| | | | | the entropy | Tensile shear |
| | | | TES | elastomer | strength |
| | Board 1 | Board 2 | treatment | layer | (MP a) |
| Example 9 | Al | SUS | With | Yes | 10.5 |
| Example 10 | Al | EP | | | 10.5 |
| Example 11 | PA | EP | | | 9 |
| Example 12 | Glass | Al | | | 8.6 |
| | plate | | | | |
| Example 13 | Glass | PA | | | 9 |
| | plate | | | | |
| Example 14 | Glass | Glass | | | 13 |
| | plate | plate | | | |
| Comparative | Al | SUS | Without | Yes | Peeled before |
| example 9 | | | | | measurement |
| Comparative | Al | EP | | | Peeled before |
| example 10 | | | | | measurement |
| Comparative | PA | EP | | | 0.2 |
| example 11 | | | | | |
| Comparative | Glass | Al | | | Peeled before |
| example 12 | plate | | | | measurement |
| Comparative | Glass | PA | | | 0.1 |
| example 13 | plate | | | | |
| Comparative | Glass | Glass | | | Peeled before |
| example 14 | plate | plate | | | measurement |
| Comparative | Al | SUS | With | No | Peeled before |
| example 15 | | | | | measurement |
| Comparative | Al | EP | | | Peeled before |
| example 16 | | | | | measurement |
| Comparative | PA | EP | | | Peeled before |
| example 17 | | | | | measurement |
| Comparative | Glass | Al | | | Peeled before |
| example 18 | plate | | | | measurement |
| Comparative | Glass | PA | | | Peeled before |
| example 19 | plate | | | | measurement |
| Comparative | Glass | Glass | | | Peeled before |
| example 20 | plate | plate | | | measurement |

It became known that the breakage of the entropy elastomer layer between the board partners was observed, and the elastomer was bonded onto the board partners at the high peel strength when the board partners each having the TES linked hereto were pasted together with the entropy elastomer layer interposed therebetween.

### Exemplary Example 15

### Manufacturing the (I) Subjected to the Hydroxylation Treatment

The boards (I-1) and (I-2) subjected to the hydroxylation treatment were manufactured by using an aluminum plate (Al, 1×30×50 mm, made of the Nilaco corporation) as the board 1, and a glass epoxy resin plate (EP, 0.2×30×50 mm, FR-4 made by Panasonic Electric works) as the board 2 and performing the corona discharge treatment of which a number of roundtrips is three with an output power of 13 kW at a speed of 2 m/minute using the corona discharging apparatus made by Kasuga electric works Ltd.

### Manufacturing the Board Having the Molecular Adhesive Linked Hereto (II)

The boards each having the molecular adhesive linked hereto (II-1) and (II-2) were obtained by immersing the obtained boards (I-1) and (I-2) in a 95% water/ethanol (0.2% by weight) solution of the molecular adhesive TES for five minutes, thereafter, heating them in the oven for 10 minutes at a temperature of 150° C., and performing the ethanol cleaning/drier drying.

### Manufacturing the Laminated Body (V)

The laminated body (V) of the board partners via the entropy elastomer bonding layer was obtained by interposing the sheet of the entropy elastomer composition (3) used in the exemplary example 9 between the boards (II-1) and (II-2) in a sandwiching manner, and heating them for 30 minutes at a temperature of 160° C. under the pressurization.

### Exemplary Example 16

The laminated body (V) was obtained similarly to the exemplary example 15 except that 3-aminopropyltriethoxysilane (APS, KBE-903 made by Shin-Etsu chemical Co. LTD.) was used as the molecular adhesive instead of the TES.

### Exemplary Example 17

The laminated body (V) was obtained similarly to the exemplary example 15 except that a mixture (hereinafter, sometimes referred to as “S4+DB”) of 1:1 (mole ratio) of bis(triethoxysilylpropyl)tetrasulfide (KBE-846 made by Shin-Etsu chemical Co. LTD.), and 2-dibutylamino-1,3,5-triazine-4,6-dithiol was used as the molecular adhesive instead of the TES, and the entropy elastomer composition (4) shown in the following Table 8 was used instead of the entropy elastomer composition (3).

### Exemplary Example 18

The laminated body (V) was obtained similarly to the exemplary example 15 except that the VMS was used as the molecular adhesive instead of the TES, and the sheet of the entropy elastomer composition (1) used in the exemplary example 1 was used instead of the entropy elastomer composition (3).

### Exemplary Example 19

The laminated body (V) was obtained similarly to the exemplary example 15 except that 6-bis(3-(triethoxysilylpropyl)amino-1,3,5-triazine-2,4-dithiol-monosodium (BTES) was used as the molecular adhesive instead of the TES.

### Comparative Exemplary Examples 21 to 23

The laminated bodies (V) were obtained by using the boards and the entropy elastomers shown in Table 4 and performing a treatment similar to the treatment of the exemplary example 15 except that the molecular adhesive treatment was not performed.

<Molecular Adhesive Linkage Confirmation>

Confirmation of the linkage between the board and each of the various molecular adhesives was carried out by measuring all elements with X-ray Photoelectron Spectroscopy XPS (Perkin Elmer PHI5600ESCA system made by ULVAC-PHI) after the treatment.

It became clear from a result of the XPS measurement that existence of an S2p peak based upon sulfur atoms originating in the TES and the S4, and an Si2p peak based upon silicon atoms originating in the APS and the VMS was observed and the board and each of the various molecular adhesives were linked when performing the various molecular adhesive treatments for two kinds of the boards of the metal (Al) and the resin (EP) after the corona discharge treatment (see FIG. 4). However, no atom of sulfur and silicon was detected in the comparative exemplary example experiment in which no molecular adhesive treatment was performed.

<The Method of Measuring the Strength>

The shear/peel strength of the adhesiveness of the board partners was obtained by mounting the entropy elastomer of 1.25 cm×0.6 cm onto the edge of the board of 1.25 cm×50 cm, preparing shear/peel strength test samples, and peeling them at a speed of 50 mm/minute with a tensile testing machine (Autograph P-100 made by Shimadzu Corporation).

A result thereof is shown in Table 4. Additionally, the entropy elastomers described in Table 4 and the tables after it are the entropy elastomer compositions having components (ratio by weight) shown in table 8, and are shown in the tables by the abbreviated names described in Table 8.

TABLE 4

| | | | | | Tensile shear |
|---|---|---|---|---|---|
| | | | Entropy | Molecular | strength |
| | Board 1 | Board 2 | elastomer | adhesive | (MP a) |
| Example 15 | Al | EP | CHR | TES | 10.5 |
| Example 16 | Al | EP | CHR | APS | 6.3 |
| Example 17 | Al | EP | NBR | S4 + DB | 10 |
| Example 18 | Al | EP | Q | VMS | 4.4 |
| Example 19 | Al | EP | CHR | BTES | 9.8 |
| Comparative | Al | EP | CHR | Without | Peeled before |
| example 21 | | | | treatment | measurement |
| Comparative | Al | EP | NBR | Without | Peeled before |
| example 22 | | | | treatment | measurement |
| Comparative | Al | EP | Q | Without | Peeled before |
| example 23 | | | | treatment | measurement |

It became known that the breakage of the entropy elastomer layer between the board partners was observed, and the elastomer was bonded onto the board partners at the high peel strength similarly to the case of other investigations when the board partners each having the various molecular adhesives linked hereto were pasted together with the entropy elastomer layer interposed therebetween.

### Exemplary Example 20

### Manufacturing the Board (I) Subjected to the Hydroxylation Treatment

The boards (I-1) and (I-2) subjected to the hydroxylation treatment were manufactured by using an aluminum plate (Al, 1×30×50 mm, made of the Nilaco corporation) as the board 1, and a glass epoxy resin plate (EP, 0.2×30×50 mm, FR-4 made by Panasonic Electric works) as the board 2, respectively, and performing the corona discharge treatment of which a number of roundtrips is three with an output power of 13 kW at a speed of 2 m/minute using the corona discharging apparatus made by Kasuga electric works Ltd.

### Manufacturing the Board Having the Molecular Adhesive Linked Hereto (II)

The boards each having the molecular adhesive linked hereto (II-1) and (II-2) were obtained by immersing the obtained boards (I-1) and (I-2) in a 95% water/ethanol (0.2% by weight) solution of the molecular adhesive TES for five minutes, thereafter, heating them in the oven for 10 minutes at a temperature of 150° C., and performing the ethanol cleaning/drier drying.

### Manufacturing the Laminated Body (V)

The laminated body (V) of the board partners via the entropy elastomer bonding layer was obtained by interposing the sheet of the entropy elastomer composition (3) used in the exemplary example 9 between the obtained boards (II-1) and (II-2) in a sandwiching manner, and heating them for 30 minutes at a temperature of 160° C. under the pressurization.

### Exemplary Examples 21-28

The laminated bodies (V) were obtained similarly to the exemplary example 20 except the boards, the molecular adhesives, and the entropy elastomers shown in Table 5 were adopted. Additionally, “PE” in Table 5 indicates the sheet that is comprised of commercially available polyethylene (made by KOKUGO, 30×60×1 mm, product name: Rigid-type polyethylene sheet).

### Comparative Exemplary Examples 24-32

The laminated bodies (V) were obtained by using the boards and the entropy elastomers shown in Table 5 and performing a treatment similar to the treatment of the exemplary example 20 except that the molecular adhesive treatment was not performed.

<Molecular Adhesive Linkage Confirmation>

It became clear from a result of the XPS measurement that existence of an S2p peak based upon sulfur atoms originating in the TES and the S4, and an Si2p peak based upon silicon atoms originating in the APS was observed, respectively, and the board and each of the various molecular adhesives were linked when performing the various molecular adhesive treatments for the boards after the corona discharge treatment (see FIG. 4). However, no atom of sulfur and silicon was detected in the comparative exemplary example experiment in which no molecular adhesive treatment was performed.

TABLE 5

| | | | | | Tensile shear |
|---|---|---|---|---|---|
| | | | Entropy | Molecular | strength |
| | Board 1 | Board 2 | elastomer | adhesive | (MP a) |
| Example 20 | Al | EP | CHR | TES | 10.5 |
| Example 21 | Al | EP | EPDM | TES | 7 |
| Example 22 | Al | EP | FKM | TES | 6 |
| Example 23 | Al | EP | NR | APS | 4.5 |
| Example 24 | Al | EP | Q | TES | 2.6 |
| Example 25 | Al | EP | BR (S8) | S4 + DB | 7 |
| Example 26 | Al | SUS | PE | TES | 9.7 |
| Example 27 | Al | Mg | PE | TES | 9.7 |
| Example 28 | Copper | PA | Q | TES | 3.5 |
| | plate | | | | |
| Comparative | Al | EP | CHR | Without | Peeled before |
| example 24 | | | | treatment | measurement |
| Comparative | Al | EP | EPDM | Without | Peeled before |
| example 25 | | | | treatment | measurement |
| Comparative | Al | EP | FKM | Without | Peeled before |
| example 26 | | | | treatment | measurement |
| Comparative | Al | EP | NR | Without | Peeled before |
| example 27 | | | | treatment | measurement |
| Comparative | Al | EP | Q | Without | Peeled before |
| example 28 | | | | treatment | measurement |
| Comparative | Al | EP | BR (S8) | Without | Peeled before |
| example 29 | | | | treatment | measurement |
| Comparative | Al | SUS | PE | Without | Peeled before |
| example 30 | | | | treatment | measurement |
| Comparative | Al | Mg | PE | Without | Peeled before |
| example 31 | | | | treatment | measurement |
| Comparative | Copper | PA | Q | Without | Peeled before |
| example 32 | plate | | | treatment | measurement |

It became known that the breakage of the rubber layer between the board partners was observed, and the elastomer was bonded onto the board partners at the high peel strength, similarly to the case of other investigations, when the board partner each having the various molecular adhesives linked hereto were pasted together with the entropy elastomer interposed therebetween.

### Exemplary Examples 29-36

### Manufacturing the Board (I) Subjected to the Hydroxylation Treatment and the Board Having the Molecular Adhesive Linked Hereto (II)

The boards (I) subjected to the hydroxylation treatment were manufactured by using the boards shown in a column of the board 1 of Table 6, and performing the corona discharge treatment under a condition similar to the condition of the exemplary example 1. The boards having the molecular adhesive linked hereto (II) were obtained by performing the treatment for the obtained board (I) with the molecular adhesives shown in a column of the molecular adhesives 1 of Table 6. Additionally, the condition of the treatment with the molecular adhesives is identical to that of the foregoing example using the identical molecular adhesive.

### Manufacturing the Bonded Product (III) of the Board and the Entropy Elastomer

The bonded product (III) of the board and the entropy elastomer (the thickness of the elastomer is approximately, 1.2 mm) was obtained by pasting together the molecular adhesive layer forming surface of the obtained board (II) and the sheet (approximately, 1.5 mm) of the entropy elastomer composition shown in a column of the elastomers of Table 6 and heating them for 10 minutes at a temperature of 160° C. under a pressure of 5 MPa. The peel strength was measured for this bonded product (III) with a method similar to the foregoing <strength measurement method>. A result thereof is shown in a column of the peel strength 1 of Table 6.

### Manufacturing the Board Having the Entropy Elastomer Bonded Thereon (IV)

The boards having the entropy elastomer bonded thereon (IV) were obtained by performing the corona discharge treatment for the surfaces of the elastomer of the obtained bonded products (III) similarly to the foregoing, and thereafter performing the treatment with the molecular adhesives shown in a column of the molecular adhesive 2 of Table 6. Additionally, the condition of the treatment with the molecular adhesives is identical to that of the foregoing example using the identical molecular adhesive.

### Manufacturing the Laminated Body (V)

The laminated bodies (V) having the plating layer of which the plating thickness was approximately 40 pm were obtained by performing the electroless plating under a condition similar to that of the exemplary example 1, and furthermore, the electric copper plating for the obtained boards having the entropy elastomer bonded thereon (IV). The peel strength was measured for these laminated bodies (V) with a method similar to the foregoing <strength measurement method>. A result thereof is shown in a column of the peel strength 2 of Table 6.

TABLE 6

| | | | | Peel | | | Peel |
|---|---|---|---|---|---|---|---|
| | | Molecular | Entropy | strength 1 | Molecular | | strength 2 |
| | Board 1 | adhesive 1 | elastomer | (MP a) | adhesive 2 | Board 2 | (MP a) |
| Example 29 | PET¹⁾ | TES | Q | 3.5 | TES | Copper | 3.1 |
| | | | | | | plating | |
| Example 30 | Alumina | TES | Q | 3.8 | TES | Copper | 2.6 |
| | | | | | | plating | |
| Example 31 | EP | TES | Q | 3.6 | TES | Copper | 3.5 |
| | | | | | | plating | |
| Example 32 | PI | TES | Q | 3.4 | TES | Copper | 2.9 |
| | | | | | | plating | |
| Example 33 | PET¹⁾ | S4 + DB | NBR | 10 | TES | Copper | 2 |
| | | | | | | plating | |
| Example 34 | Alumina | S4 + DB | NBR | 9.8 | TES | Copper | 2.5 |
| | | | | | | plating | |
| Example 35 | EP | S4 + DB | NBR | 13 | TES | Copper | 1.9 |
| | | | | | | plating | |
| Example 36 | PI | S4 + DB | NBR | 9 | TES | Copper | 1.7 |
| | | | | | | plating | |

¹⁾PET: Polyethylene terephthalate board (made by TOYOBO CO., LTD, 30 × 60 × 1 mm)

### Exemplary Examples 37-53

### Manufacturing the Board (I) Subjected to the Hydroxylation Treatment and the Board Having the Molecular Adhesive Linked Hereto (II)

The laminated bodies (V) were obtained under a condition similar to that of the exemplary example 9 except that the boards shown in a column of the board 1 of Table 7 were used as the board 1, the boards shown in a column of the board 2 of Table 7 were used as the board 2, the molecular adhesives shown in a column of the molecular adhesive of Table 7 were used as the molecular adhesives, and the entropy elastomers shown in a column of the entropy elastomer of Table 7 were used as the entropy elastomer. The peel strength of these laminated bodies (V) was measured with a method similar to the foregoing <strength measurement method>. A result thereof is shown in a column of the peel strength of Table 7. Additionally, the so-called “S4+DA” shown in a column of the molecular adhesives of Table 7 indicates a mixture of 1:1 (mole ratio) of bis(triethoxysilylpropyl)tetrasulfide (KBE-846 made by Shin-Etsu chemical Co., LTD.), and 2-diallylamino-1,3,5-triazine-4,6-dithiol.

TABLE 7

| | | | | | Peel |
|---|---|---|---|---|---|
| | | Molecular | | Entropy | strength |
| | Board 1 | adhesive | Board 2 | elastomer | 2 (MP a) |
| Example 37 | Al | S4 + DA | SUS | BR (S8) | 7.1 |
| Example 38 | Al | S4 + DA | EP | BR (S8) | 6.8 |
| Example 39 | PA | S4 + DA | EP | BR (S8) | 6.5 |
| Example 40 | Glass | S4 + DA | Al | BR (S8) | 7.2 |
| | plate | | | | |
| Example 41 | Glass | S4 + DA | PA | BR (S8) | 7.5 |
| | plate | | | | |
| Example 42 | Glass | S4 + DA | Glass | BR (S8) | 7.8 |
| | plate | | plate | | |
| Example 43 | Al | APS | SUS | NR | 3.5 |
| Example 44 | PA | APS | EP | NR | 4.2 |
| Example 45 | Glass | APS | Al | NR | 4.1 |
| | plate | | | | |
| Example 46 | Glass | APS | PA | NR | 4.5 |
| | plate | | | | |
| Example 47 | Glass | APS | Glass | NR | 4.6 |
| | plate | | plate | | |
| Example 48 | Al | TES | SUS | BR (PO) | 7.1 |
| Example 49 | Al | TES | EP | BR (PO) | 6.8 |
| Example 50 | PA | TES | EP | BR (PO) | 6.5 |
| Example 51 | Glass | TES | Al | BR (PO) | 7.2 |
| | plate | | | | |
| Example 52 | Glass | TES | PA | BR (PO) | 7.5 |
| | plate | | | | |
| Example 53 | Glass | TES | Glass | BR (PO) | 7.8 |
| | plate | | plate | | |

TABLE 8

| Entropy | | | | | | | | |
|---|---|---|---|---|---|---|---|---|
| elastomer | | | | | | | | |
| compositions | | | | | | | | |
| abbreviated | | | | | | | | |
| names of | | | | | | (6) | (7) | |
| Table 1 to | (1) | (2) | (3) | (4) | (5) | BR | BR | (8) |
| Table 7 | EPDM | Q | CHR | NBR | FKM | (S8) | (PO) | NR |
| EPDM¹⁾ | 100 | | — | — | — | — | | |
| CHR²⁾ | | | 100 | — | — | — | | |
| NBR³⁾ | | | — | 100 | — | — | | |
| FKM⁴⁾ | | | — | — | 100 | — | | |
| BR⁵⁾ | | | — | — | — | 100 | 100 | |
| Q⁶⁾ | | 100 | | | | | | |
| NR¹⁵⁾ | | | | | | | | 100 |
| Carbon | 50 | | 40 | 40 | 40 | 40 | 40 | 40 |
| black⁷⁾ | | | | | | | | |
| Silica⁸⁾ | | 40 | | | | | | |
| Sulfur (S8) | | | — | 2 | | 2 | | 1.5 |
| ZISNET-F⁹⁾ | | | 1 | — | | | | |
| DCP¹⁰⁾ | 5 | | | | | | 2 | |
| Perhexa | | 5 | | | 1.5 | | | |
| 25B¹¹⁾ | | | | | | | | |
| TAIC¹²⁾ | | | | | 4 | | | |
| MBTS¹³⁾ | | | — | 1 | — | 1 | 1 | 1 |
| TMTD¹⁴⁾ | | | — | | — | — | | |
| ZnO | 5 | | — | 5 | | 5 | 5 | 5 |
| MgO | | | 3 | — | — | — | | |
| Stearate | 1 | | 1 | 1 | — | 1 | 1 | 1 |

¹⁾Ethylene propylene terpolymer (EPDM, EP92 made by JSR)
²⁾Epichlorohydrin rubber (CHR, product name; Zekron 2000 made by Zeon Corporation)
³⁾Acrylnitrile-butadiene copolymer rubber (NBR, product name; nipole1042 made by Zeon Corporation)
⁴⁾Fluoro rubber (FKM, product name; Dyer G80-1 made by Daikin industries, Ltd.)
⁵⁾1,4-cisbutadiene rubber (BR, product name; nipoleBR made by Zeon Corporation)
⁶⁾Silicone rubber (Q, SH852U made by Dow Corning Toray, Silicone)
⁷⁾Carbon black (SRF Carbon Asahi #40 made by ASAHI CARBON CO. LTD.)
⁸⁾Silica (MHDF treated silica, product name; Nipple Seal made by TOSOH SILICA CORPORATION)
⁹⁾ZISNET-F (crosslinking agent made by Sannkyou Kasei)
¹⁰⁾dicumyl peroxide (DCP made by NOF CORPORATION)
¹¹⁾2,5-dimethyl-2,5-di(t-butylperoxy)hexan: (Perhexa 25B made by NOF CORPORATION)
¹³⁾MBTS (DM made by OUCHI SHINKO CHEMICAL INDUSTRIAL CO., LTD.)
¹⁴⁾TMTD (TT made by OUCHI SHINKO CHEMICAL INDUSTRIAL CO., LTD.)
¹⁵⁾Natural rubber (NR)

### INDUSTRIAL APPLICABILITY

The present invention is useful in many fields such as automobile industries, electron appliance industries, medicine appliance industries, air space industries, and construction industries.

1-18. (canceled)

19. A laminated body, obtained by a process of multilayering a first board and a second board, the process comprising:
forming an entropy elastomer layer between said first board and said second board;
wherein said first board and said entropy elastomer layer are bonded with at least one compound represented by formula (1), and
wherein said second board and said entropy elastomer layer are bonded with the at least one compound represented by formula (1)
A-SiX¹₍₃₋ₙ₎Yₙ (1),
wherein
A is a group linkable to the entropy elastomer layer,
X¹ is a hydrogen atom, or a saturated or unsaturated aliphatic hydrocarbon group having a carbon number of 1 to 10 that optionally comprise at least one substituted group, and each X¹ is identical or different,
Y is an alkyloxy group having a carbon number of 1 to 10, and
n is 1, 2, or 3.

20. The laminated body according to claim 19, wherein said first or second board has OH groups on a surface of a side facing said entropy elastomer layer.

21. The laminated body according to claim 19, wherein said entropy elastomer layer has OH groups on a surface of a side facing said first or second board.

22. The laminated body according to claim 19, wherein said first or second board and said entropy elastomer layer are bonded by a reaction between OH groups of a board surface facing said entropy elastomer layer and the at least one compound represented by said formula (1).

23. The laminated body according to claim 19, wherein said first or second board and said entropy elastomer layer are bonded by a reaction between OH groups of each entropy elastomer layer surface facing a respective board surface and the at least one compound represented by said formula (1).

24. The laminated body according to claim 19, wherein the at least one compound represented by said formula (1) is correspondingly formed on an entire surface or a part of a surface of said first or second board.

25. The laminated body according to claim 19, wherein said first and second board comprise at least one material selected from the group consisting of a metal, a ceramic, and a resin.

26. The laminated body according to claim 19, wherein said entropy elastomer layer is a layer comprising at least one polymer material of which a glass transition point is equal to or lower than a temperature at a time of forming said laminated body.

27. The laminated body according to claim 19, wherein said entropy elastomer layer comprises at least one selected from the group consisting of natural rubber, 1,4-cisbutadiene rubber, isoprene rubber, styrene-butadiene copolymer rubber, hydrogenated styrene-butadiene copolymer rubber, acrylonitrile-butadiene copolymer rubber, hydrogenated acrylonitrile-butadiene copolymer rubber, ethylene-propylene-diene rubber, chloroprene rubber, fluorine rubber, epichlorohydrin rubber, fluorinated silicone rubber, peroxide silicone rubber, addition silicone rubber, and condensation silicone rubber.

28. The laminated body according to claim 19, wherein the at least one compound represented by said formula (1) is represented by formula (2) 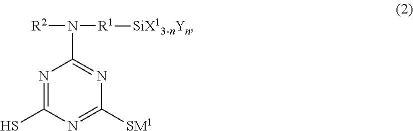
wherein
R¹ is a single bond, a saturated or unsaturated aliphatic hydrocarbon group having a carbon number of 1 to 20, or an aromatic hydrocarbon group wherein said aliphatic hydrocarbon group or aromatic hydrocarbon group optionally comprises —NH—, —CO—, —O—, —S—, or —COO—,
R² is a hydrogen atom, a saturated or unsaturated aliphatic hydrocarbon group having a carbon number of 1 to 10 that optionally comprises at least one substituted group, or an aromatic hydrocarbon group that optionally comprises at least one substituted group,
X¹ is a hydrogen atom, or a saturated or unsaturated aliphatic hydrocarbon group having a carbon number of 1 to 10 that optionally comprises at least one substituted group, and each X¹ is identical or different,
Y is an alkyloxy group having a carbon number of 1 to 10,
n is 1, 2, or 3, and
M¹ is H, Li, Na, K, or Cs.

29. The laminated body according to claim 19, wherein the at least one compound represented by said formula (1) is represented by formula (3) 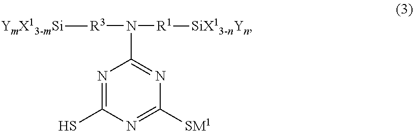
wherein
each of R¹ and R³ is identical or different and is a single bond, a saturated or unsaturated aliphatic hydrocarbon group having a carbon number of 1 to 20, or an aromatic hydrocarbon group, wherein said aliphatic hydrocarbon group or aromatic hydrocarbon group optionally comprises —NH—, —CO—, —O—, —S—, or —COO—,
X¹ is a hydrogen atom, or a saturated or unsaturated aliphatic hydrocarbon group having a carbon number of 1 to 10 that optionally comprises at least one substituted group, and each X¹ is identical or different,
Y is an alkyloxy group having a carbon number of 1 to 10,
n is 1, 2, or 3,
m is 1, 2, or 3, and
M¹ is H, Li, Na, K, or Cs.

30. The laminated body according to claim 19, wherein the at least one compound represented by said formula (1) is represented by formula (4) 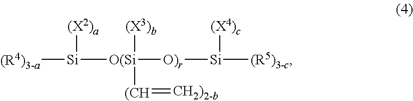
wherein
R⁴ and R⁵ are identical or different and are a saturated or unsaturated aliphatic hydrocarbon group having a carbon number of 1 to 10 that optionally comprises at least one substituted group, or an aromatic hydrocarbon group that optionally comprises at least one substituted group,
each of X² to X⁴ is a saturated or unsaturated aliphatic hydrocarbon group having a linear or branched carbon chains with a carbon number of 1 to 10 that optionally comprise at least one substituted group, an aromatic hydrocarbon group that optionally comprises at least one substituted group, or an alkyloxy group having a carbon number of 1 to 10, whereby at least one of X² and X⁴ is an alkyloxy group,
a is 0, 1, 2, or 3,
b is 0, 1, or 2,
c is 0, 1, 2, or 3,
r represents an integer of 0 to 100.

31. The laminated body according to claim 19, wherein the at least one compound represented by said formula (1) is represented by formula (5)
[X⁵_{d}(X⁶O)_{(3-d)}SiR⁶]ₑZ (5),
wherein
each X⁵ and X⁶ is identical or different and is a saturated or unsaturated aliphatic hydrocarbon group having a carbon number of 1 to 4,
R⁶ is a bivalent aliphatic hydrocarbon group having a carbon number of 1 to 18, or an aromatic hydrocarbon group, whereby the aliphatic hydrocarbon group of R⁶ optionally comprises —NH—, —CO—, —O—, —S—, —COO—, or —C₆H₄—,
Z is —SH, —SCSN(CH₃)₂, —SSCSN(CH₃)₂, —SCSN(C₂H₅)₂, —SCSN(C₄H₉)₂, —SCSN(C₈H₁₇)₂, —SS—, —SSS—, —SSSS—, 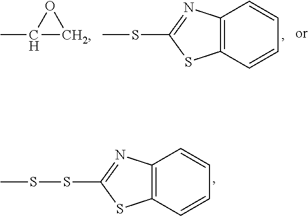
d is 0, 1, or 2, and
e is 1 or 2.

32. The laminated body according to claim 19, wherein the at least one compound represented by said formula (1) is represented by formula (6)
H₂N—R⁷—SiX¹₍₃₋ₙ₎Yₙ (6),
wherein
R⁷ is a saturated or unsaturated aliphatic hydrocarbon group having a carbon number of 1 to 10 that optionally comprises at least one substituted group, or an aromatic hydrocarbon group that optionally comprises at least one substituted group,
X¹ is a hydrogen atom, or a saturated or unsaturated aliphatic hydrocarbon group having a carbon number of 1 to 10 that optionally comprises at least one substituted group, and each X¹ is identical or different,
Y is an alkyloxy group having a carbon number of 1 to 10, and
n is 1, 2, or 3.

33. The laminated body according to claim 19, wherein at least one of said first board and said second board is a conductive board.

34. The laminated body according to claim 19, wherein at least one of said first board and said second board is a plating film.

35. The laminated body according to claim 34, wherein said laminated body is a circuit wiring board.

36. The laminated body according to claim 19, wherein said laminated body is a decorative plating commodity.

37. The laminated body according to claim 19, wherein a force in a direction in which said first board and said second board closely approach to each other is applied at the time of multilayering.

38. A method of manufacturing a laminated body, comprising:
(A) forming at least one compound represented by formula (1),
A-SiX¹₍₃₋ₙ₎Yₙ (1),
wherein
A is a group linkable to the entropy elastomer layer,
X¹ is a hydrogen atom, or a saturated or unsaturated aliphatic hydrocarbon group having a carbon number of 1 to 10 that optionally comprises at least one substituted group, and each X¹ is identical or different,
Y is an alkyloxy group having a carbon number of 1 to 10, and
n is 1, 2, or 3,
on a first board;
(B) forming an entropy elastomer layer on the at least one compound represented by said formula (1) after said forming (A);
(C) forming the at least one compound represented by formula (1) on said entropy elastomer layer after said forming (B);
(D) forming a second board on the at least one compound represented by said formula (1) after said forming (C); and
(E) applying a force, thereby causing said entropy elastomer layer and said first board and/or said second board to closely approach to each other.

39. A method of manufacturing a laminated body, comprising:
(a) forming at least one compound represented by formula (1)
A-SiX¹₍₃₋ₙ₎Yₙ (1),
wherein
A is a group linkable to the entropy elastomer layer,
X¹ is a hydrogen atom, or a saturated or unsaturated aliphatic hydrocarbon group having a carbon number of 1 to 10 that substituted group, and each X¹ is identical or different,
Y is an alkyloxy group having a carbon number of 1 to 10, and
n is 1, 2, or 3,
on a first board;
(b) forming the at least one compound represented by formula (1) on a second board;
(c) arranging an entropy elastomer layer between the at least one compound represented by said formula (1) obtained in said forming (a) and the at least one compound represented by said formula (1) obtained in said forming (b); and
(d) applying a force, thereby causing said entropy elastomer layer and said first board and/or said second board to closely approach to each other.
